(19) United States
(12) Patent Application Publication
(10) Pub. No.: US 2025/0337514 A1
(43) Pub. Date: Oct. 30, 2025

(54) DISTRIBUTED DEVICE CLUSTER

(71) Applicant: Huawei Technologies Co., Ltd., Shenzhen (CN)

(72) Inventor: Hamid Mehrvar, Ottawa (CA)

(21) Appl. No.: 18/646,653

(22) Filed: Apr. 25, 2024

(51) Int. Cl. H04J 14/02

(52) U.S. Cl. CPC H04J 14/0212; H04J 14/02219; H04J 14/0282

(57) ABSTRACT

A distributed device cluster includes a plurality of devices and a plurality of connection lines. Each device includes at least one pair of transmission components each including a first transmission component and a second transmission component that are coupled to each other. For any two of the plurality of devices, a first transmission component in one device is coupled to a second transmission component in another device via at least one connection line.

### TECHNICAL FIELD

The present disclosure relates to the field of data transmission, and in particular, to a distributed device cluster.

### BACKGROUND

In the field of data transmission, the traffic of data that needs to be transmitted by data transmission devices continues to grow. However, due to the design of the components within the device, the amount of data traffic that a single device can transmit per unit of time, as well as directions or paths in which data can be transmitted, are limited. Therefore, it is necessary to expand the data traffic and the directions or paths for the device to adapt the growth of traffic across the entire network.

### SUMMARY

A distributed device cluster is provided, which includes a plurality of devices and a plurality of connection lines. Each device includes at least one pair of transmission components each including a first transmission component and a second transmission component that are coupled to each other. For any two of the plurality of devices, a first transmission component in one device is coupled to a second transmission component in another device via at least one connection line.

In some embodiments, each device further includes an inter-connection component, the first transmission component and the second transmission component in the device are coupled via the inter-connection component, and the inter-connection component is used for transmitting at least a portion of data from the first transmission component to the second transmission component.

In some embodiments, the inter-connection component is a switch. For any two of the plurality of devices, the first transmission component in one device is coupled to the at least one connection line, and the switch and the second transmission component in another device in sequence.

In some embodiments, the first transmission component has one common port for coupling with a first fiber, and K branch ports; the second transmission component has one common port for coupling with a second fiber, and K branch ports; K is a positive integer. Each pair of transmission components is located in at least one line card, and the line card further includes T transmission medium pairs each including a first transmission medium with transmission channels and a second transmission medium with transmission channels; the T transmission medium pairs are used for coupling with different devices of the plurality of devices. The K branch ports of the first transmission component are divided into T+1 groups of branch ports, and the K branch ports of the second transmission component are divided into T+1 groups of branch ports. In the line card, a first group of branch ports in the first transmission component and a first group of branch ports in the second transmission component are coupled, an i-th group of branch ports in the first transmission component and a first transmission medium of an (i−1)-th transmission medium pair are coupled, and an i-th group of branch ports in the second transmission component and a second transmission medium of the (i−1)-th transmission medium pair are coupled; i is a positive integer greater than or equal to 2 and less than or equal to (T+1), T is a positive integer, and K is greater than (T+1). For any two of the plurality of devices, a first transmission medium in one device is coupled to a second transmission medium in another device via a connection line, and a second transmission medium in one device is coupled to a first transmission medium in the another device via another connection line.

In some embodiments, T is greater than or equal to 2.

In some embodiments, the inter-connection component is an optical backplane. The first transmission component and the second transmission component, the first transmission component and the first transmission medium, and the second transmission component and the second transmission medium are coupled via the optical backplane.

In some embodiments, the first transmission component in each line card is fully connected to second transmission components in all line cards in the distributed device cluster; and/or the second transmission component in each line card is fully connected to first transmission components in all line cards in the distributed device cluster.

In some embodiments, at least one of the plurality of devices includes P line cards. In the P line cards, P branch ports in the first group of branch ports of the first transmission component in each line card are coupled to P branch ports of P second transmission components, each of the P branch ports of the P second transmission components being located in the first group of branch ports of one second transmission component; P is an integer greater than or equal to 2; and in the P line cards, P branch ports in the i-th group of branch ports of the first transmission component in each line card are coupled to P first transmission media, each of the P first transmission media being located in an (i−1)-th transmission medium pair in one line card.

In some embodiments, in the P line cards, P branch ports in the first group of branch ports of the second transmission component in each line card are coupled to P branch ports of P first transmission components, each of the P branch ports of the P first transmission components being located in the first group of branch ports of one first transmission component; and in the P line cards, P branch ports in the i-th group of branch ports of the second transmission component in each line card are coupled to P second transmission media, each of the P second transmission media being located in an (i−1)-th transmission medium pair in one line card.

In some embodiments, the at least one device includes at least two devices; any two of the at least two devices are referred to as a first device and a second device, and the P line cards in the first device are in one-to-one correspondence with the P line cards in the second device. For a line card in the first device and a line card in the second device that are correspond, the first transmission medium of one transmission medium pair in the line card of the first device is coupled to the second transmission medium of one transmission medium pair in the line card of the second device via a connection line, and the second transmission medium of the transmission medium pair in the line card of the first device is coupled to the first transmission medium of the transmission medium pair in the line card of the second device via another connection line.

In some embodiments, the at least one of the plurality of devices includes a first device, and the plurality of devices further include a third device; and the third device includes Q line cards, Q is a positive integer less than P. In the Q line cards, Q branch ports in the first group of branch ports of the first transmission component in each line card are coupled to Q branch ports of Q second transmission components, each of the Q branch ports of the Q second transmission components being located in the first group of branch ports of one second transmission component; and Q branch ports in the first group of branch ports of the second transmission component in each line card are coupled to Q branch ports of Q first transmission components, each of the Q branch ports of the Q first transmission components being located in the first group of branch ports of one first transmission component. In the Q line cards, P branch ports in a second group of branch ports of the first transmission component in each line card are coupled to the first transmission medium of a first transmission medium pair in the line card, and P branch ports in a second group of branch ports of the second transmission component in each line card are coupled to the second transmission medium of the first transmission medium pair in the line card.

In some embodiments, the Q line cards in the third device are in one-to-one correspondence with Q line cards in the first device. For a line card in the first device and a line card in the third device that are correspond, the first transmission medium of the first transmission medium pair in the line card of the first device is coupled to the second transmission medium of the first transmission medium pair in the line card of the third device via a connection line, and the second transmission medium of the first transmission medium pair in the line card of the first device is coupled to the first transmission medium of the first transmission medium pair in the line card of the third device via another connection line.

In some embodiments, the first transmission component includes at least one first wavelength select switch (WSS), and the second transmission component includes at least one second WSS.

In some embodiments, the first transmission component includes a splitter with one common port and M branch ports, and M first WSSs respectively coupled to the M branch ports of the splitter, each first WSS having K/M branch ports; K is greater than M, and both M and K/M are positive integers greater than or equal to 2; and/or the second transmission component includes a combiner with one common port and M branch ports, and M second WSSs respectively coupled to the M branch ports of the combiner, each second WSS having K/M branch ports.

In some embodiments, the device further includes an add-drop card, and the add-drop card includes an add module and a drop module. The drop module is coupled to one branch port in the first group of branch ports of the first transmission component and one transmission channel of each of T second transmission media in the T transmission medium pairs in each line card; in the first transmission component, the branch port coupled to the drop module is different from branch ports coupled to second transmission components; in the T second transmission media, transmission channels coupled to the drop module are different from those coupled to second transmission components. The add module is coupled to one branch port in the first group of branch ports of the second transmission component and one transmission channel of each of T first transmission media in the T transmission medium pairs in each line card; in the second transmission component, the branch port coupled to the add module is different from branch ports coupled to first transmission components; in the T first transmission media, transmission channels coupled to the add module are different from those coupled to first transmission components.

In some embodiments, the add module includes (T+1) multiplexers corresponding to each line card, and the drop module includes (T+1) de-multiplexers corresponding to each line card.

In some embodiments, a de-multiplexer is a WSS; and/or a multiplexer is a WSS.

In some embodiments, the distributed device cluster further includes a plurality of micro-electro-mechanical system (MEMS). The add module of each device is connected to an MEMS, and the drop module of each device is connected to another MEMS.

In some embodiments, the distributed device cluster further includes a plurality of add chassis and a plurality of drop chassis, and each add chassis includes a plurality of CDC cards and each drop chassis includes a plurality of CDC cards. The add module in each device is connected to all CDC cards in an add chassis, and the drop module in each device is connected to all CDC cards in a drop chassis. The CDC card is an add-drop component that is colorless, directionless, and contentionless.

In some embodiments, the distributed device cluster further includes a master controller. The device further includes a controller coupled to the master controller. The master controller is configured to: determine a data transmission path according to data received by any first transmission component; in a case of determining the data transmission path involving two target devices, determine a first transmission medium in a first target device, and a second transmission medium and a second transmission component in a second target device through which data transmission passes, and then generate an instruction; send the instruction to a controller of the first target device, instructing the controller of the first target device to transmit data from a target branch port of the first transmission component to the first transmission medium to route the data to the second transmission medium of the second target device; and send the instruction to the controller of the second target device, instructing the controller of the second target device to receive the data from the first target device and assign the data to the second transmission component for output. The master controller is further configured to, in a case of determining the data transmission path involving one target device, instruct a controller of the target device to transmit the data from the target branch port of the first transmission component to the second transmission component for output.

### BRIEF DESCRIPTION OF THE DRAWINGS

In order to describe technical solutions in the present disclosure more clearly, accompanying drawings to be used in some embodiments of the present disclosure will be introduced briefly below. Obviously, the accompanying drawings to be described below are merely accompanying drawings of some embodiments of the present disclosure, and a person of ordinary skill in the art can obtain other drawings according to these drawings.

FIG. 1 is a schematic diagram of a distributed device cluster, in accordance with some embodiments of the present disclosure;

FIG. 2A is a schematic diagram of another distributed device cluster, in accordance with some embodiments of the present disclosure;

FIG. 2B is a schematic diagram of yet another distributed device cluster, in accordance with some embodiments of the present disclosure;

FIG. 3 is a schematic diagram of yet another distributed device cluster, in accordance with some embodiments of the present disclosure;

FIG. 4A to 4G are schematic diagrams of connections in a device, in accordance with some embodiments of the present disclosure;

FIG. 5 is a schematic diagram showing a connection between devices in the distributed device cluster, in accordance with some embodiments of the present disclosure;

FIG. 6A is a schematic diagram showing another connection between devices in the distributed device cluster, in accordance with some embodiments of the present disclosure;

FIG. 6B is a schematic diagram showing yet another connection between devices in the distributed device cluster, in accordance with some embodiments of the present disclosure;

FIG. 7 is another schematic diagram of connections in a device, in accordance with some embodiments of the present disclosure;

FIG. 8 is yet another schematic diagram of connections in a device, in accordance with some embodiments of the present disclosure;

FIG. 9 is a schematic diagram showing yet another connection between devices in the distributed device cluster, in accordance with some embodiments of the present disclosure;

FIG. 10A is a schematic diagram showing structures of a first transmission component and a second transmission component, in accordance with some embodiments of the present disclosure;

FIG. 10B is a schematic diagram showing structures of another first transmission component and another second transmission component, in accordance with some embodiments of the present disclosure;

FIG. 10C is a schematic diagram showing a line card and a faceplate of the line card, in accordance with some embodiments of the present disclosure;

FIG. 11 is a schematic diagram showing connection to an add-drop card, in accordance with some embodiments of the present disclosure;

FIG. 12 is a schematic diagram of chassis of a ROADM node, in accordance with some embodiments of the present disclosure;

FIG. 13 is a schematic diagram of chassis of another ROADM node, in accordance with some embodiments of the present disclosure;

FIG. 14 is a schematic diagram of a CDC card, in accordance with some embodiments of the present disclosure;

FIG. 15 is a schematic diagram of a ROADM node, in accordance with some embodiments of the present disclosure; and

FIG. 16 is a schematic diagram of a control process of a master controller, in accordance with some embodiments of the present disclosure.

### DETAILED DESCRIPTION OF ILLUSTRATIVE EMBODIMENTS

Technical solutions in embodiments of the present disclosure will be described clearly and completely with reference to the accompanying drawings below. Obviously, the described embodiments are merely some but not all embodiments of the present disclosure. All other embodiments obtained by a person of ordinary skill in the art based on the embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed as open and inclusive meanings, i.e., “including, but not limited to”. In the description, the terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials or characteristics may be included in any one or more embodiments or examples in any suitable manner.

Hereinafter, the terms “first” and “second” are used for descriptive purposes only, and are not to be construed as indicating or implying the relative importance or implicitly indicating the number of indicated technical features. Thus, a feature defined with “first” or “second” may explicitly or implicitly include one or more of the features. In the description of the embodiments of the present disclosure, the terms “a/the plurality of” and “multiple” means two or more unless otherwise specified.

Orientation terms such as “top”, “bottom”, “left” and “right” are defined relative to the indicated position of the components in the drawings. It will be understood that these orientation terms are relative concepts that can be used for relative description and clarification, and they can change accordingly if the orientation of the components changes in the drawings.

In the description of some embodiments, the terms “coupled” and “connected” and derivatives thereof may be used. For example, the term “connected” may be used in the description of some embodiments to indicate that two or more components are in direct physical or electrical contact with each other. For another example, the term “coupled” may be used in the description of some embodiments to indicate that two or more components are in direct physical or electrical contact. However, the term “coupled” may also mean that two or more components are not in direct contact with each other, but still cooperate or interact with each other. The embodiments disclosed herein are not necessarily limited to the content herein.

The phrase “A and/or B” includes the following three combinations: only A, only B, and a combination of A and B.

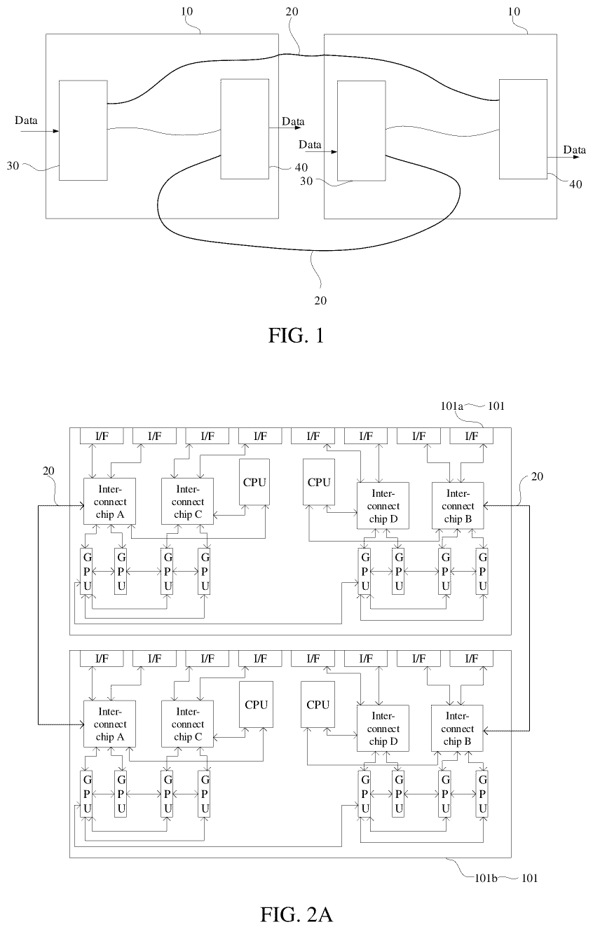

Some embodiments of the present disclosure provide a distributed device cluster, as shown in FIG. 1, the distributed device cluster includes a plurality of devices i and a plurality connection lines 20. Each device 10 includes at least one pair of transmission components each including a first transmission component 30 and second transmission component 40 that are coupled to each other. For any two of the plurality of devices 10, the first transmission component 30 in one device 10 is coupled to the second transmission component 40 in the other device 10 via at least one connecting line 20.

For example, in each device 10, the first transmission component 30 is used to input data into the device 10, and the second transmission component 40 is used to output data from the device 10 to an external device.

For any two devices 10 in the distributed device cluster, the first transmission component 30 in any device 10 is coupled to the second transmission component 40 of the same device 10, as well as to the second transmission component 40 in the other device 10 via at least one connection line 20. Therefore, the first transmission component 30 in any device 10 may not only transmit data to the second transmission component 40 in the same device 10 for further transmission to a next transmission node connected to the device 10, but also transmit data to the second transmission component 40 in the other device 10 for further transmission to a next transmission node connected to the other device 10.

Thus, data input into any device 10 may be allocated to multiple devices 10, thereby increasing the capacity of the distributed device cluster several times over as a data transmission node. This expansion method may directly utilize existing devices (chassis), saving the cost for expanding data flow at data transmission nodes. In addition, the distributed device cluster relies on a collection of the plurality of devices 10 to expand the direction or path of data transmission for the first transmission component 30 of any device 10.

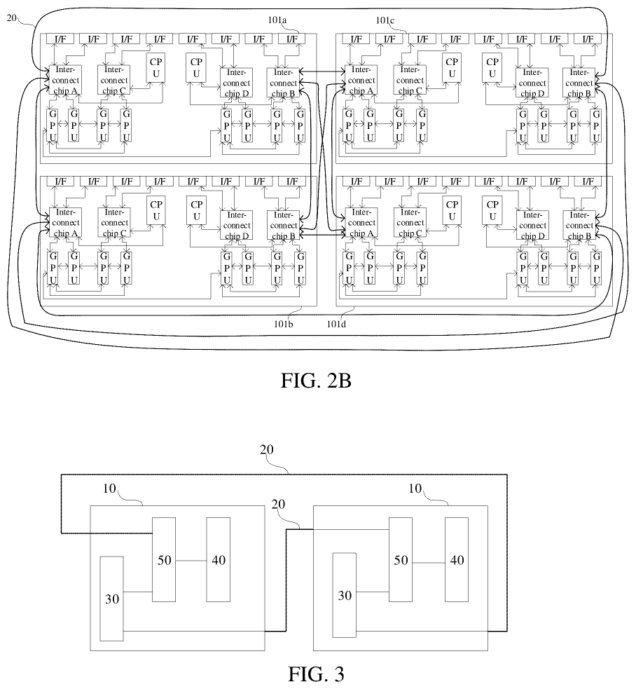

In some embodiments, as shown in FIGS. 2A and 2B, the device 10 of the distributed device cluster is a server 101 with built-in inter-connection chips. Each inter-connection chip is used to connect various components in the server 101, e.g., connecting a server interface to a graphics processing unit (GPU), connecting a server interface to a central processing unit (CPU), and connecting the CPU to GPU, thereby achieving data transmission between components.

FIG. 2A illustrates two servers 101a, 101b as an example. The two servers 101a, 101b each include four inter-connection chips, which are an inter-connection chip A, inter-connection chip B, inter-connection chip C, and inter-connection chip D. In the server 101a, the inter-connection chip A serves as the first transmission component 30, and the inter-connection chip B serves as the second transmission component 40. In the server 101b, the inter-connection chip B serves as the first transmission component 30, and the inter-connection chip A serves as the second transmission component 40. The inter-connection chip A in the server 101a is connected to the inter-connection chip A in the server 101b via connection line(s) 20, and the inter-connection chip B in the server 101a is connected to the inter-connection chip B in the server 101b via connection line(s) 20. Thus, data from all components connected to the inter-connection chip A in the server 101a may be transmitted to all components connected to the inter-connection chip A in the server 101b, and data from all components connected to the inter-connection chip B in the server 101b may be transmitted to all components connected to the inter-connection chip B in the server 101a.

For example, the inter-connection chip A in the server 101a is bi-directionally connected to the inter-connection chip A in the server 101b via a single connection line 20, and the inter-connection chip B in the server 101a is bi-directionally connected to the inter-connection chip B in the server 101b via another single connection line 20. For another example, the inter-connection chip A in the server 101a is bi-directionally connected to the inter-connection chip A in the server 101b via two connection lines 20. That is, for any of the server 101a and server 101b, one connection line 20 is used for input, and the other connection line 20 is used for output. Similarly, the inter-connection chip B in the server 101a is bi-directionally connected to the inter-connection chip B in the server 101b via two connection lines 20. It can be understood that the use of one or two connecting lines 20 depends on whether the connection interface of the inter-connection chip is unidirectional or bidirectional transmission.

Based on this, the inter-connection chip A in the server 101b can also serve as the first transmission component 30, and correspondingly, the inter-connection chip A in the server 101a can serve as the second transmission component 40; the inter-connection chip B in the server 101a can serve as the first transmission component 30, and correspondingly, the inter-connection chip B in the server 101b can serve as the second transmission component 40. Therefore, data from all components connected to the inter-connection chip A in the server 101b may be transmitted to all components connected to the inter-connection chip A in the server 101a, and data from all components connected to the inter-connection chip B in the server 101a may be transmitted to all components connected to the inter-connection chip B in the server 101b.

As a result, data transmission may be performed between the inter-connection chip A in the server 101a and the inter-connection chip A in the server 101b, and between the inter-connection chip B in the server 101a and the inter-connection chip B in the server 101b. Therefore, by using the same two servers, the capacity may be doubled without changing the server (chassis size remains unchanged).

FIG. 2B illustrates four servers 101a, 101b, 101c and 101d as an example. Each of the four servers includes four inter-connection chips, which are an inter-connection chip A, inter-connection chip B, inter-connection chip C, and inter-connection chip D. For the connections between servers 101a and 101b, and between servers 101c and 101d, reference may be made to the above description for the servers 101a and 101b in FIG. 2A. The inter-connection chip A in the server 101a is further connected to the inter-connection chip B in the server 101c and the inter-connection chip B in the server 101d via connection lines 20, and the inter-connection chip B in the server 101a is further connected to the inter-connection chip A in the server 101c and the inter-connection chip A in the server 101d via connection lines 20. The inter-connection chip A in the server 101b is further connected to the inter-connection chip B in the server 101c and the inter-connection chip B in the server 101d via connection lines 20, and the inter-connection chip B in the server 101b is further connected to the inter-connection chip A in the server 101c and the inter-connection chip A in the server 101d via connection lines 20.

Therefore, data from each server may be transmitted to the other three servers. By using the same 4 servers, the capacity may be expanded by 4 times.

In some embodiments, as shown in FIG. 3, the device 10 further includes an inter-connection component 50, the first transmission component 30 and the second transmission component 40 in the device 10 are coupled via the inter-connection component 50, and the inter-connection component 50 is used for transmitting at least a portion of data from the first transmission component 30 to the second transmission component 40. Through the inter-connection component 50, data may be transmitted between different devices 10, thereby achieving the capacity allocation between devices 10.

The specific type of the inter-connection component 50 is not limited here and depends on the type of the device 10 and its application scenario.

In some embodiments, as shown in FIG. 3, the devices 10 in the distributed device cluster are routers, and the inter-connection component 50 in the device 10 is a switch. For any two devices 10 in the distributed device cluster, the first transmission component 30 in any device 10 is coupled to the at least one connection line 20, and the switch and the second transmission component 40 in the other device 10 in sequence. Based on this, data input into any device 10 may be processed by switches in multiple devices 10, enhancing the switching capacity and processing efficiency.

In the case where the device 10 is the router and the inter-connection component 50 is the switch, the first transmission component 30 can serve as an ingress chip and the second transmission component 40 can serve as an egress chip. For any two routers in the cluster, the ingress chip of any router is coupled to the switch in the other router via a connection line 20. Data from the ingress chip may be transmitted to the egress chip via the switch in the same router, and may also be transmitted to the switch in the other router via a connection line 20 and then transmitted to the egress chip in the other router.

In some embodiments, the device 10 is the server 101 with built-in inter-connection chips shown in FIGS. 2A and 2B, and the inter-connection component 50 is the CPU.

In some embodiments, the device 10 is a reconfigurable add-drop multiplexer (ROADM), and the inter-connection component 50 is a set of inter-connection lines, an optical backplane, or other component capable of coupling the first transmission component 30 and second transmission component 40 in the devices 10. In this case, the distributed device cluster can also be referred to as a ROADM node.

In optical networks, the ROADM node is used to perform various functions on light beams of different wavelengths. For example, the ROADM node adds, drops, and redirects light beams of specific wavelengths. In general, the degree of the ROADM node is defined as the total number of fiber pairs (including an input fiber and an output fiber) connected to the ROADM node.

ROADM nodes play a key role in switching and transporting of high volume of data. The ROADM node is characterized by two parameters, one is the number of directions (i.e., the number of degrees), and the other is the number of wavelengths that can be added or dropped. The number of degrees of the ROADM node determines its capacity. With increased traffic (i.e., increased demand for network capacity), there are needs for the ROADM with higher number of degrees and scalable capacity to allow transmission in many different directions and a corresponding flexibility.

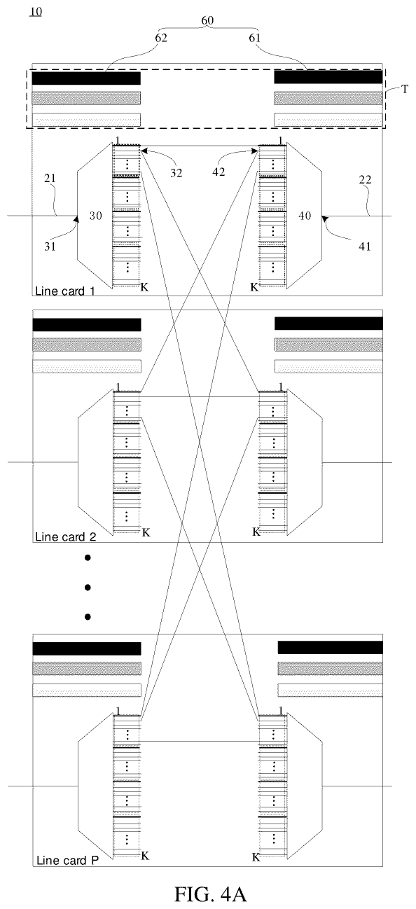

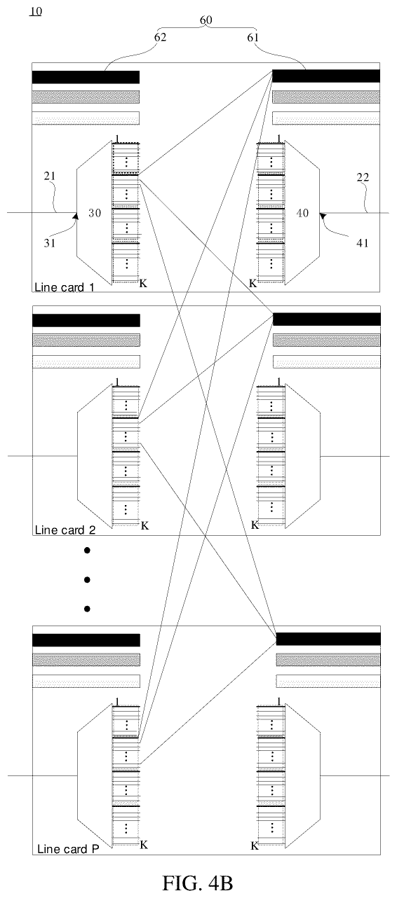

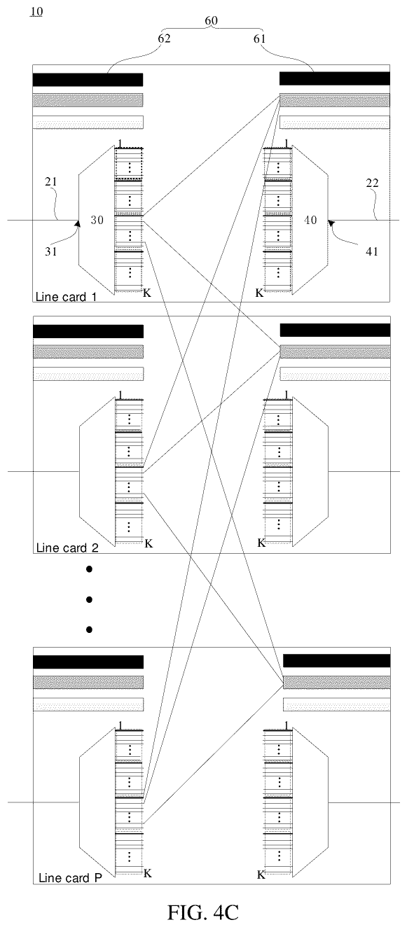

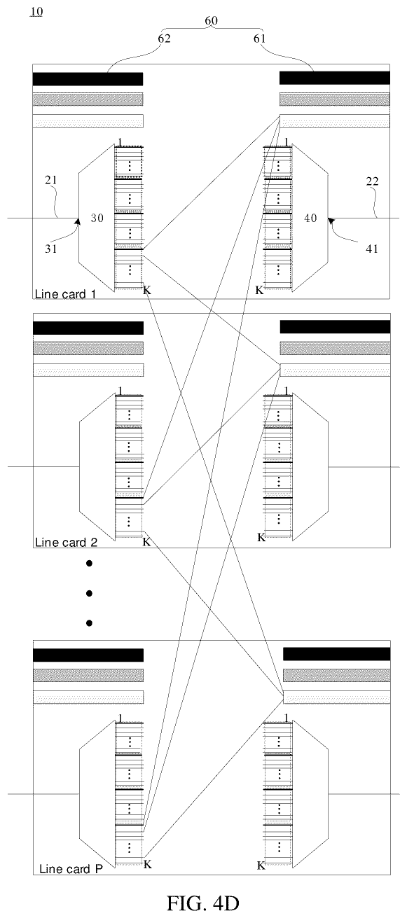

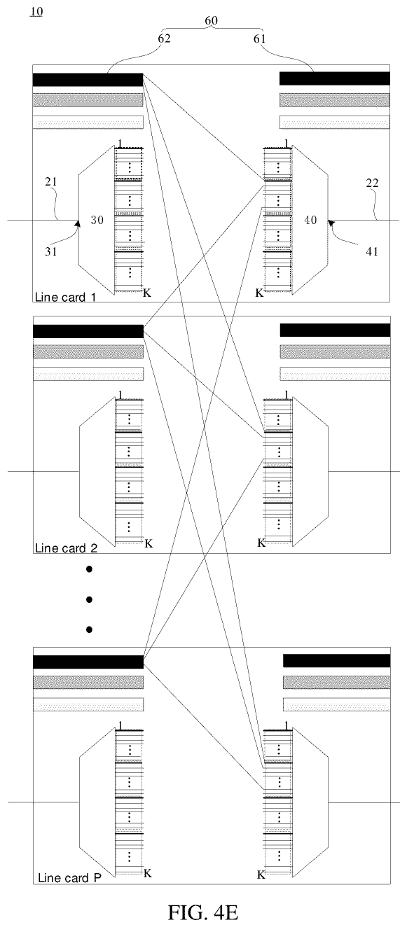

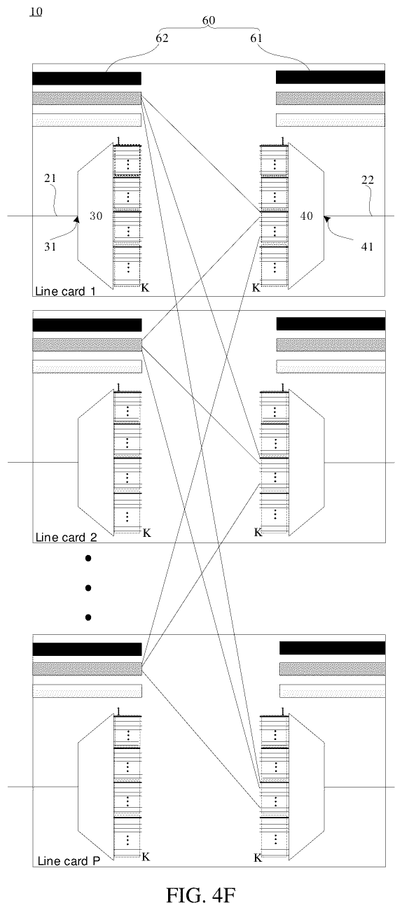

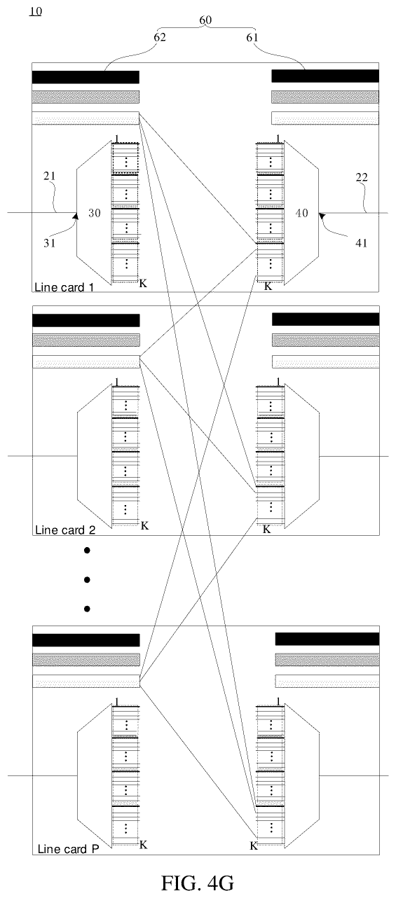

Based on this, in some embodiments, as shown in FIGS. 4A to 4G, the first transmission component 30 has one common port 31 for coupling with a first fiber 21, and K branch ports 32; the second transmission component 40 has one common port 41 for coupling with a second fiber 22, and K branch ports 42; K is a positive integer. Each pair of transmission components is located in at least one line card, and the line card further includes T transmission medium pairs 60 each including a first transmission medium 61 with transmission channels and a second transmission medium 62 with transmission channels; the T transmission medium pairs 60 are used for coupling with different devices 10 of the plurality of devices 10. The K branch ports 32 of the first transmission component 30 are divided into T+1 groups of branch ports 32 (each group of branch ports 32 is indicated by the left dashed box in the figures), and the K branch ports 42 of the second transmission component 40 are divided into T+1 groups of branch ports 42 (each group of branch ports 42 is indicated by the right dashed box in the figures). In the line card, a first group of branch ports 32 in the first transmission component 30 and a first group of branch ports 42 in the second transmission component 40 are coupled, an i-th group of branch ports 32 in the first transmission component 30 and a first transmission medium 61 of an (i−1)-th transmission medium pair 60 are coupled, and an i-th group of branch ports 42 in the second transmission component 40 and a second transmission medium 62 of the (i−1)-th transmission medium pair 60 are coupled. i is a positive integer greater than or equal to 2 and less than or equal to (T+1), T is a positive integer, and K is greater than (T+1). For any two of the plurality of devices 10, the first transmission medium 61 in one device 10 is coupled to the second transmission medium 62 in the other device 10 via a connection line 20, and the second transmission medium 62 in one device 10 is coupled to the first transmission medium 61 in the other device 10 via another connection line 20.

For example, K is 8, 16, 32, 64, or any other value.

For example, the numbers of branch ports 32 in different groups in the first transmission component 30 are equal or different. In the case where the number of branch ports 32 in each group in the first transmission component 30 is equal, K is an integer multiple of (T+1).

For example, the numbers of branch ports 42 in different groups in the second transmission component 40 are equal or different. In the case where the number of branch ports 42 in each group in the second transmission component 40 is equal, K is an integer multiple of (T+1).

For example, a pair of transmission components is located in the same line card, but the embodiments of the present disclosure are not limited thereto, the first transmission component 30 and the second transmission component 40 in the pair of transmission components may be located in different line cards.

For example, the first fiber 21 is the input fiber, and the second fiber 22 is the output fiber; alternatively, the second fiber 22 is the input fiber, and the first fiber 21 is the output fiber. Each of the input fiber and output fiber can be a single-mode fiber (SMF) or multi-core fiber (MCF) or multiple single-core-fiber. It can be understood that the input fiber and output fiber are used to couple other ROADM nodes in the optical network. That is, a fiber pair composed of the input fiber and output fiber is used for external connections, while the transmission medium pair 60 composed of the first transmission medium 61 and the second transmission medium 62 is used for coupling between devices 10. For example, at least one of the first transmission medium 61 and the second transmission medium 62 is a fiber, such as an MCF, a fiber composed of multiple single-core fibers, a ribbon fiber, or other fiber with the form of fiber bundle.

For ease of description, the following is described by taking an example in which the first fiber 21 is the input fiber and the second fiber 22 is the output fiber.

Since each line card is coupled to the fiber pair composed of the input fiber and output fiber, each line card corresponds to one degree.

It should be noted that the T transmission medium pairs 60 in the line card are arranged in order from top to bottom in the figures. For example, T is 2, and in order from top to bottom, the T transmission medium pairs 60 are the first transmission medium pair 60 and the second transmission medium pair 60. For another example, T is 3, and in order from top to bottom, the T transmission medium pairs 60 are the first transmission medium pair 60, the second transmission medium pair 60, and the third transmission medium pair 60.

In addition, the terms “first group” and “i-th group” are indicated in order from top to bottom in the figures. For example, if T is 1, the K branch ports 32 of the first transmission component 30 are divided into two groups of branch ports 32, and in order from top to bottom, the two groups of branch ports 32 are the first group of branch ports 32 and the second group of branch ports 32; similarly, the K branch ports 42 of the second transmission component 40 are divided into two groups of branch ports 42, and in order from top to bottom, the two groups of branch ports 42 are the first group of branch ports 42 and the second group of branch ports 42. For example, if T is 2, the K branch ports 32 of the first transmission component 30 are divided into three groups of branch ports 32, and in order from top to bottom, the three groups of branch ports 32 are the first group of branch ports 32, the second group of branch ports 32, and the third group of branch ports 32; similarly, the K branch ports 42 of the second transmission component 40 are divided into three groups of branch ports 42, and in order from top to bottom, the three groups of branch ports 42 are the first group of branch ports 42, the second group of branch ports 42, and the third group of branch ports 42. For example, if T is 3, the K branch ports 32 of the first transmission component 30 are divided into four groups of branch ports 32, and in order from top to bottom, the four groups of branch ports 32 are the first group of branch ports 32, the second group of branch ports 32, the third group of branch ports 32, and the fourth group of branch ports 32; similarly, the K branch ports 42 of the second transmission component 40 are divided into four groups of branch ports 42, and in order from top to bottom, the four groups of branch ports 42 are the first group of branch ports 42, the second group of branch ports 42, the third group of branch ports 42, and the fourth group of branch ports 42.

In the embodiments of the present disclosure, due to the fact that each line card corresponds to one degree, and the limited number of line cards that can be accommodated under a fixed chassis size of the device 10, in order to meet the requirements of different degrees in various application scenarios of the ROADM node, the number of devices 10 needs to change according to the number of degrees of the ROADM node. In an example where the chassis of each device 10 can accommodate P line cards and P is set to 15, in a case where the number of degrees of the ROADM node needs to be expanded to 16, only two devices 10 are needed; one device 10 is used to place 15 line cards, and the other device 10 is used to place 1 line card. In a case where the number of degrees of the ROADM node needs to be expanded to 30, two devices 10 are needed, and each device 10 is used to place 15 line cards. In a case where the number of degrees of the ROADM node needs to be expanded to 45, three devices 10 are needed, and each device 10 is used to place 15 line cards. In a case where the number of degrees of the ROADM node needs to be expanded to 60, four devices 10 are needed, and each device 10 is used to place 15 line cards.

In a case where the actual number of required line cards is less than the total number of line cards that all chassis in the ROADM node can accommodate, only some slots in a certain chassis are placed with line cards. That is, the numbers of line cards in different devices 10 may be the same or different. For example, the chassis of each device 10 can accommodate 15 line cards, in the case where the number of degrees of the ROADM node needs to be expanded to 16, 15 line cards are placed in one device 10, and 1 line card is placed in the other device 10. In the case where the number of degrees of the ROADM node needs to be expanded to 20, 15 line cards are placed in one device 10, and 5 line card are placed in the other device 10.

In some embodiments, to facilitate coupling between devices 10, the same transmission medium pair 60 in one device 10 (referred to as a first device here) is coupled to the same device 10 (referred to as a second device here). That is, in the case where the first fiber 21 is the input fiber and the second fiber 22 is the output fiber, for the same transmission medium pair 60 in the first device, the first transmission medium 61 is coupled to an output transmission component (the second transmission component 40) in the second device, and the second transmission medium 62 is coupled to an input transmission component (the first transmission component 30) in the second device. The first transmission medium 61 is used to output data from the first device to the second device, and the second transmission medium 62 is used to input data from the second device into the first device.

Hence, the maximum number of expandable devices in the ROADM node is limited by the value of T, and the maximum number is T+1. In order to meet the expansion requirements of various application scenarios, the value of T may be greater than 1, which allows the maximum number of expandable devices in the ROADM node to exceed 2. In actual applications, in the case where only two devices 10 are needed, only one transmission medium pair 60 in the line card of one device 10 needs to be coupled with the other device 10, and the external coupling of the other transmission medium pairs 60 in the line card is vacant.

In some embodiments, T is greater than or equal to 2. Thus, the number of devices in the ROADM node may be 2, 3, or more, which may be applied to various application scenarios.

FIGS. 4A to 4G illustrates the coupling between 15 line cards in the same device 10. In actual applications, the number of line cards that can be accommodated in the device 10 is not limited to 15, and is determined according to the existing chassis, and the number of transmission medium pairs 60 is not limited to 3.

As shown in FIG. 4A, the first group of branch ports 32 of the first transmission component 30 in a device 10 (referred to as a first device here) is coupled to the first group of branch ports 42 of the second transmission component 40 in the first device. That is, the first group of branch ports 32 of the first transmission component 30 and the first group of branch ports 42 of the second transmission component 40 are used to be coupled in the same device 10.

As shown in FIG. 4B, the second group of branch ports 32 of the first transmission component 30 in the first device is coupled to the first transmission medium 61 of the first transmission medium pair 60, and the first transmission medium 61 is used to be coupled to another device 10 (referred to as a second device here). That is, the second group of branch ports 32 of the first transmission component 30 in the first device is used to be coupled to the second device. Thus, data from the second group of branch ports 32 may be transmitted to the second device through the first transmission medium 61 of the first transmission medium pair 60.

As shown in FIG. 4C, the third group of branch ports 32 of the first transmission component 30 in the first device is coupled to the first transmission medium 61 of the second transmission medium pair 60, and the first transmission medium 61 is used to be coupled to another device 10 (referred to as a third device here). That is, the third group of branch ports 32 of the first transmission component 30 in the first device is used to be coupled to the third device. Thus, data from the third group of branch ports 32 may be transmitted to the third device through the first transmission medium 61 of the second transmission medium pair 60.

As shown in FIG. 4D, the fourth group of branch ports 32 of the first transmission component 30 in the first device is coupled to the first transmission medium 61 of the third transmission medium pair 60, and the first transmission medium 61 is used to be coupled to another device 10 (referred to as a fourth device here). That is, the fourth group of branch ports 32 of the first transmission component 30 in the first device is used to be coupled to the fourth device. Thus, data from the fourth group of branch ports 32 may be transmitted to the fourth device through the first transmission medium 61 of the third transmission medium pair 60.

In this way, the first transmission component may not only transmit some data to the second transmission component in the same device but also transmit some data to other devices. Therefore, the egress traffic of the first transmission component may be allocated to multiple devices, thereby achieving the expansion of transferrable data traffic as well as data transmission directions or paths.

As shown in FIG. 4E, the second group of branch ports 42 of the second transmission component 40 in the first device is coupled to the second transmission medium 62 of the first transmission medium pair 60, and the second transmission medium 62 is used to be coupled to the second device. That is, the second group of branch ports 42 of the second transmission component 40 in the first device is used to be coupled to the second device. Thus, the second group of branch ports 42 may receive data from the second device through the second transmission medium 62 of the first transmission medium pair 60.

As shown in FIG. 4F, the third group of branch ports 42 of the second transmission component 40 in the first device is coupled to the second transmission medium 62 of the second transmission medium pair 60, and the second transmission medium 62 is used to be coupled to the third device. That is, the third group of branch ports 42 of the second transmission component 40 in the first device is used to be coupled to the third device. Thus, the third group of branch ports 42 may receive data from the third device through the second transmission medium 62 of the second transmission medium pair 60.

As shown in FIG. 4G, the fourth group of branch ports 42 of the second transmission component 40 in the first device is coupled to the second transmission medium 62 of the third transmission medium pair 60, and the second transmission medium 62 is used to be coupled to the fourth device. That is, the fourth group of branch ports 42 of the second transmission component 40 in the first device is used to be coupled to the fourth device. Thus, the fourth group of branch ports 42 may receive data from the fourth device through the second transmission medium 62 of the third transmission medium pair 60.

In this way, the second transmission component may not only receive some data from the first transmission component in the same device but also receive some data from other devices. Therefore, the ingress traffic of the second transmission component may be allocated to multiple devices, thereby achieving the expansion of the transferable data traffic as well as data transmission directions or paths.

In the embodiments of the present disclosure, in each device 10, the first group of branch ports 32 of the first transmission component 30 and the first group of branch ports 42 of the second transmission component 40 are coupled; each of other groups of branch ports 32, except for the first group of branch ports 32, of the first transmission component 30 is coupled to a corresponding device through a first transmission medium 61 of one of the T transmission medium pairs 60; and each of other groups of branch ports 42, except for the first group of branch ports 42, of the second transmission component 40 is coupled, through a second transmission medium 62 of one of the T transmission medium pairs 60, to another device corresponding thereto. Therefore, the expansion of the number of devices in the ROADM node may be achieved simply by connections between the transmission medium pairs of the devices, thereby achieving the expansion of the degree and capacity of the ROADM node. Moreover, in a case where the number of devices in the ROADM node is sufficient, the degree may be increased simply by inserting new line cards into the device 10. Furthermore, whether inserting new line cards or adding new device(s), the ROADM node does not stop operating, so that the node performance may be maintained. In addition, since the number of the devices in the ROADM node provided in the embodiments in the present disclosure may be expanded, the existing chassis may be utilized. Thus, it is possible to allow customers to retain investment in previously purchased chassis and to ensure forward and backward compatibility for at least one generation of the node.

In some embodiments, in the device 10, the coupling between the first transmission component 30 and the second transmission component 40, the coupling between the first transmission component 30 and the first transmission medium 61, and the coupling between the second transmission component 40 and the second transmission medium 62 may be achieved through an optical backplane. In this way, the wiring of the device 10 is neat and aesthetic.

In some embodiments, the first transmission component 30 and the second transmission component 40 have the same structure. Thus, the structure of the line card is simple.

In some embodiments, as shown in FIGS. 4A to 4G, the first transmission component 30 in each line card is fully connected to second transmission components 40 in all line cards in the distributed device cluster; and/or the second transmission component 40 in each line card is fully connected to first transmission components 30 in all the line cards of the distributed device cluster.

In this way, during transmission of signals from the input fibers to the output fibers, wavelengths received by an input fiber in any degree may be assigned to an output fiber in any degree, and the output fiber in any degree may receive wavelengths transmitted by the input fibers in all degrees, thereby achieving mesh connectivity and enabling the ROADM node to have colorless and directionless abilities.

In some embodiments, at least one device 10 in the plurality of devices includes P line cards. As shown in FIGS. 4A to 4D, in the P line cards, P branch ports 32 in the first group of branch ports 32 of the first transmission component 30 in each line card are coupled to P branch ports 42 of P second transmission components 40, each of the P branch ports 42 of the P second transmission components 40 being located in the first group of branch ports 42 of one second transmission component 40. That is, the P branch ports 32 in the first group of branch ports 32 of the first transmission component 30 in each line card are in one-to-one correspondence with the P second transmission components 40 in the P line cards, and each branch port 32 in the first group of branch ports 32 is coupled to one branch port 42 of the first group of branch ports 42 in the respective second transmission component 40. P is a positive integer greater than or equal to 2.

In the P line cards, P branch ports 32 in the i-th group of branch ports 32 of the first transmission component 30 in each line card are coupled to P first transmission media 61, each of the P first transmission media 61 being located in an (i−1)-th transmission medium pair 60 in one line card. That is, the P branch ports 32 of the i-th group of branch ports 32 of the first transmission component 30 in each line card are in one-to-one correspondence with the P line cards, and each branch port 32 in the i-th group of branch ports 32 is coupled to the first transmission medium 61 of the (i−1)-th transmission medium pair 60 in the respective line card.

The number P of the line cards is less than the number of branch ports 32 in each group of branch ports 32 of the first transmission component 30, as well as less than the number of branch ports 42 in each group of branch ports 42 of the second transmission component 40.

For example, as shown in FIG. 4A, P=15, a device 10 (e.g., the first device) includes 15 line cards. That is, the device 10 includes 15 first transmission components 30 and 15 second transmission components 40. For the 1st line card, 15 branch ports 32 in the first group of branch ports 32 of the first transmission component 30 in the line card are in one-to-one correspondence with 15 second transmission components 40 in the same device, and each of the 15 branch ports 32 is coupled to a first branch port 42 of the respective second transmission component 40. For the 2nd line card, 15 branch ports 32 in the first group of branch ports 32 of the first transmission component 30 in the line card are in one-to-one correspondence with 15 second transmission components 40 in the same device, and each of the 15 branch ports 32 is coupled to a second branch port 42 of the respective second transmission component 40. By analogy, for the 15th line card, 15 branch ports 32 in the first group of branch ports 32 of the first transmission component 30 in the line card are in one-to-one correspondence with 15 second transmission components 40 in the same device, and each of the 15 branch ports 32 is coupled to a fifteenth branch port 42 of the respective second transmission component 40. Thus, it is possible to achieve that any first transmission component 30 is fully connected to all the second transmission components 40 in the first device.

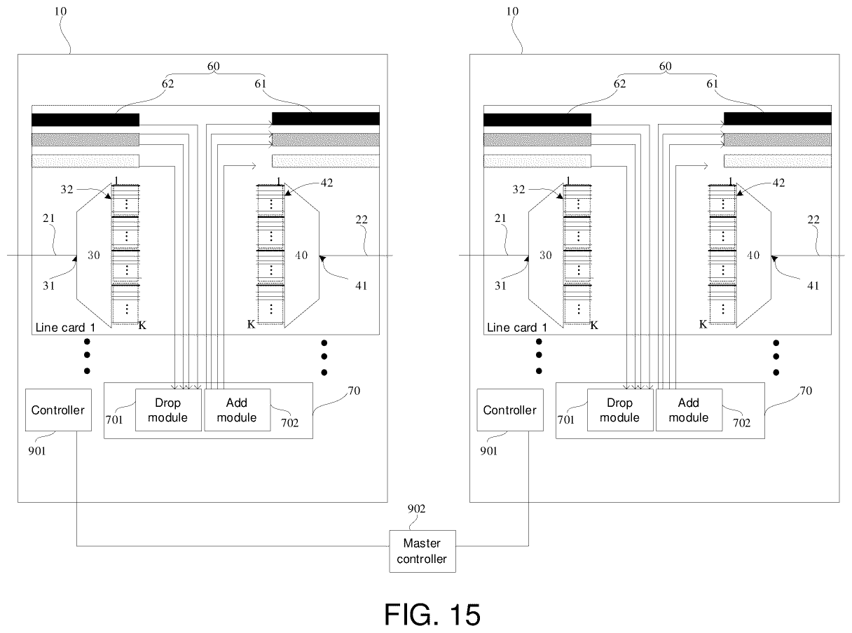

As shown in FIGS. 4B to 4D, 15 first transmission components 30 in the device 10 (e.g., the first device) are fully connected to second transmission components 40 in other devices through first transmission media 61 in the 15 line cards. For each line card, 15 branch ports 32 in the second group of branch ports 32 of the first transmission component 30 in the line card are in one-to-one correspondence with the 15 line cards in the same device, each of the 15 branch ports 32 is coupled to the first transmission medium 61 of the 1st transmission medium pair 60 in the respective line card, and the first transmission medium 61 of the 1st transmission medium pair 60 is used to be coupled to the second transmission medium 62 of the 1st transmission medium pair 60 in another device 10 (e.g., the second device); 15 branch ports 32 in the third group of branch ports 32 of the first transmission component 30 in the line card are in one-to-one correspondence with the 15 line cards in the same device, each of the 15 branch ports 32 is coupled to the first transmission medium 61 of the 2nd transmission medium pair 60 in the respective line card, and the first transmission medium 61 of the 2nd transmission medium pair 60 is used to be coupled to the second transmission medium 62 of the 2nd transmission medium pair 60 in another device 10 (e.g., the third device); 15 branch ports 32 in the fourth group of branch ports 32 of the first transmission component 30 in the line card are in one-to-one correspondence with the 15 line cards in the same device, each of the 15 branch ports 32 is coupled to the first transmission medium 61 of the 3rd transmission medium pair 60 in the respective line card, and the first transmission medium 61 of the 3rd transmission medium pair 60 is used to be couple to the second transmission medium 62 of the 3rd transmission medium pair 60 in another device 10 (e.g., the fourth device). In this way, it is possible to achieve that any first transmission component in the first device is fully connected to all second transmission components in other devices through the first transmission media in each line card.

In some embodiments, as shown in FIG. 4A and FIGS. 4E to 4G, in the P line cards, P branch ports 42 in the first group of branch ports 42 of the second transmission component 40 in each line card are coupled to P branch ports 32 of P first transmission components 30, each of the P branch ports 32 of the P first transmission components 30 being located in the first group of branch ports 32 of one first transmission component 30. That is, the P branch ports 42 in the first group of branch ports 42 of the second transmission component 40 in each line card are in one-to-one correspondence with the P first transmission components 30 in the P line cards, and each branch port 42 in the first group of branch ports 42 is coupled to one branch port 32 in the first group of branch ports 32 of the respective first transmission component 30.

In the P line cards, P branch ports 42 in the i-th group of branch ports 42 of the second transmission component 40 in each line card are coupled to P second transmission media 62, each of the P second transmission media 62 being located in an (i−1)-th transmission medium pair 60 in one line card. That is, the P branch ports 42 in the i-th group of branch ports 42 of the second transmission component 40 in each line card are in one-to-one correspondence with the P line cards, and each branch port 42 in the i-th group of branch ports 42 is coupled to the second transmission medium 62 of the (i−1)-th transmission medium pair 60 in the respective line card.

For example, as shown in FIG. 4A, P=15, a device 10 (e.g., the first device) includes 15 line cards. That is, the device 10 includes 15 first transmission components 30 and 15 second transmission components 40. For the 1st line card, 15 branch ports 42 in the first group of branch ports 42 of the second transmission component 40 in the line card are in one-to-one correspondence with the 15 first transmission components 30 in the same device, and each of the 15 branch ports 42 is coupled to the first branch port 32 in the respective first transmission component 30. For the 2nd line card, 15 branch ports 42 in the first group of branch ports 42 of the second transmission component 40 in the line card are in one-to-one correspondence with the 15 first transmission components 30 in the same device, and each of the 15 branch ports 42 is coupled to the second branch port 32 in the respective first transmission component 30. By analogy, for the 15th line card, 15 branch ports 42 in the first group of branch ports 42 of the second transmission component 40 in the line card are in one-to-one correspondence with the 15 first transmission components 30 in the same device, and each of the 15 branch ports 42 is coupled to the fifteenth branch port 32 in the respective first transmission component 30. Thus, it is possible to achieve that any second transmission component 40 is fully connected to all first transmission components 30 in the first device.

As shown in FIGS. 4E to 4G, the 15 second transmission components 40 in the device 10 (e.g., the first device) are fully connected to first transmission components 30 in other devices through second transmission media 62 in the 15 line cards. For each line card, 15 branch ports 42 in the second group of branch ports 42 of the second transmission component 40 in the line card are in one-to-one correspondence with the 15 line cards in the same device, each of the 15 branch ports 42 is coupled to the second transmission medium 62 of the 1st transmission medium pair 60 in the respective line card, and the second transmission medium 62 of the 1st transmission medium pair 60 is used to be coupled to the first transmission medium 61 in the 1st transmission medium pair 60 in another device (e.g., the second device); 15 branch ports 42 in the third group of branch ports 42 of the second transmission component 40 in the line card are in one-to-one correspondence with the 15 line cards in the same device, each of the 15 branch ports 42 is coupled to the second transmission medium 62 of the 2nd transmission medium pair 60 in the respective line card, and the second transmission medium 62 of the 2nd transmission medium pair 60 is used to be coupled to the first transmission medium 61 of the 2nd transmission medium pair 60 in another device (e.g., the third device); 15 branch ports 42 in the fourth group of branch ports 42 of the second transmission component 40 in the line card are in one-to-one correspondence with the 15 line cards in the same device, each of the 15 branch ports 42 is coupled to the second transmission medium 62 of the 3rd transmission medium pair 60 in the respective line card, and the second transmission medium 62 of the 3rd transmission medium pair 60 is used to be coupled to the first transmission medium 61 of the 3rd transmission medium pair 60 in another device (e.g., the fourth device). In this way, it is possible to achieve that any second transmission component is fully connected to all first transmission components in other devices through the second transmission media in each line card.

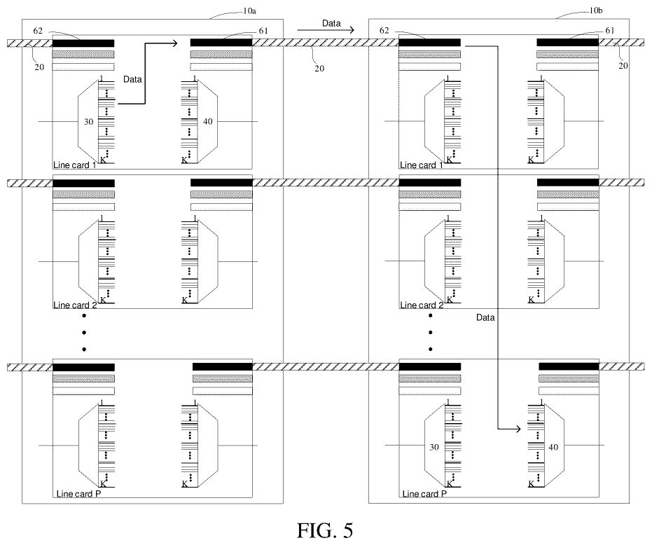

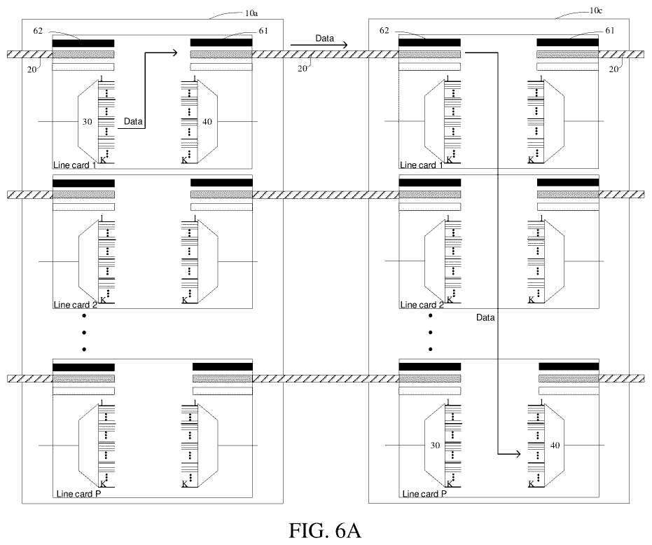

In some embodiments, as shown in FIG. 5, the at least one device 10 described above includes at least two devices 10. Any two devices 10 in the at least two devices 10 are referred to as a first device 10a and a second device 10b here (the internal connections of the two devices may be referred to in FIGS. 4A to 4G). The P line cards in the first device 10a are in one-to-one correspondence with the P line cards in the second device 10b. For a line card in the first device 10a and a line card in the second device 10b that are corresponding to each other, the first transmission medium 61 of one transmission medium pair 60 in the line card of the first device 10a is coupled to the second transmission medium 62 of one transmission medium pair 60 in the line card of the second device 10b via a connection line 20, and the second transmission medium 62 of the transmission medium pair 60 in the line card of the first device 10a is coupled to the first transmission medium 61 of the transmission medium pair 60 in the line card of the second device 10b via another connection line 20.

For example, the connection line 20 may be an MCF, a fiber composed of multiple single-core fibers, a ribbon fiber, or other fiber with the form of fiber bundle.

For example, as shown in FIG. 5, for the first line card of the first device 10a, the first transmission medium 61 and second transmission medium 62 of the first transmission medium pair 60 are coupled to the second transmission medium 62 and first transmission medium 61 of the first transmission medium pair 60 in the first line card of the second device 10b, respectively. For the second line card of the first device 10a, the first transmission medium 61 and second transmission medium 62 of the first transmission medium pair 60 are coupled to the second transmission medium 62 and first transmission medium 61 of the first transmission medium pair 60 in the second line card of the second device 10b, respectively. By analogy, for the P-th line card of the first device 10a, the first transmission medium 61 and second transmission medium 62 of the first transmission medium pair 60 are coupled to the second transmission medium 62 and first transmission medium 61 of the first transmission medium pair 60 in the P-th line card of the second device 10b, respectively.

For example, as shown in FIG. 5, P=15; in a case where data from the first direction needs to be transmitted to the thirtieth direction, the data may be transmitted from the first transmission component 30 in the first line card of the first device 10a to the second transmission component 40 in the fifteenth line card of the second device 10b through the first transmission medium 61 of the first transmission medium pair 60 in the first line card of the first device 10a and the second transmission medium 62 of the first transmission medium pair 60 in the first line card of the second device 10b, and then output from the output fiber coupled to the second transmission component 40. For another example, in a case where data from the first direction needs to be transmitted to the thirtieth direction, the data may be transmitted from the first transmission component 30 in the first line card of the first device 10a to the second transmission component 40 in the fifteenth line card of the second device 10b through the first transmission medium 61 of the first transmission medium pair 60 in the second line card of the first device boa and the second transmission medium 62 of the first transmission medium pair 60 in the second line card of the second device 10b, and then output from the output fiber coupled to the second transmission component 40. For yet another example, in a case where data from the thirtieth direction needs to be transmitted to the second direction, the data may be transmitted from the first transmission component 30 in the fifteenth line card of the second device 10b to the second transmission component 40 in the second line card of the first device boa through the first transmission medium 61 of the first transmission medium pair 60 in the fifteenth line card of the second device 10b and the second transmission medium 62 of the first transmission medium pair 60 in the fifteenth line card of the first device boa, and then output from the output fiber coupled to the second transmission component 40.

In this way, data may be transmitted from each first transmission component in the first device to each second transmission component in the second device through the first transmission medium of the first transmission medium pair in any line card in the first device, and data may be transmitted from each first transmission component in the second device to each second transmission component in the first device through the first transmission medium of the first transmission medium pair in any line card in the second device.

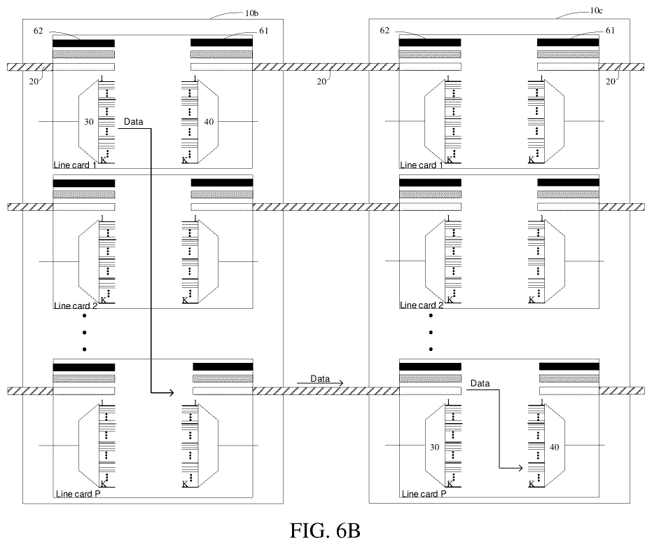

For example, as shown in FIGS. 5, 6A, and 6B, the ROADM node includes three devices 10, which are referred to as the first device 10a, the second device 10b, and the third device 10c. The coupling between the first device 10a and the second device 10b is the same as that shown in FIG. 5, and is not repeated here. The coupling between the first device 10a and the third device 10c is as shown in FIG. 6A, which is achieved through the second transmission medium pair 60 in each line card. The coupling between the second device 10b and the third device 10c is as shown in FIG. 6B, which is achieved through the third transmission medium pair 60 in each line card.

Considering an example in which P=15, as shown in FIG. 6A, in a case where data from the first direction needs to be transmitted to the forty-fifth direction, the data may be transmitted from the first transmission component 30 in the first line card of the first device 10a to the second transmission component 40 in the fifteenth line card of the third device 10c through the first transmission medium 61 of the second transmission medium pair 60 in the first line card of the first device 10a and the second transmission medium 62 of the second transmission medium pair 60 in the first line card of the third device 10c, and then output from the output fiber coupled to the second transmission component 40.

Considering an example in which P=15, as shown in FIG. 6B, in a case where data from the sixteenth direction needs to be transmitted to the forty-fifth direction, the data may be transmitted from the first transmission component 30 in the first line card of the second device 10b to the second transmission component 40 in the fifteenth line card of the third device 10c through the first transmission medium 61 of the third transmission medium pair 60 in the fifteenth line card of the second device 10b and the second transmission medium 62 of the third transmission medium pair 60 in the fifteenth line card of the third device 10c, and then output from the output fiber coupled to the second transmission component 40.

For example, the ROADM node includes four devices 10, which are referred to as the first device, the second device, the third device, and the fourth device. Coupling between the first device and the second device is achieved through the first transmission medium pair in each line card. Coupling between the first device and the third device is achieved through the second transmission medium pair in each line card. Coupling between the first device and the fourth device is achieved through the third transmission medium pair in each line card. Coupling between the second device and the third device is achieved through the third transmission medium pair in each line card. Coupling between the second device and the fourth device is achieved through the second transmission medium pair in each line card. Coupling between the third device and the fourth device is achieved through the first transmission medium pair in each line card. As for the coupling between any two devices, the reference may be made to the above description, which is not repeated here.

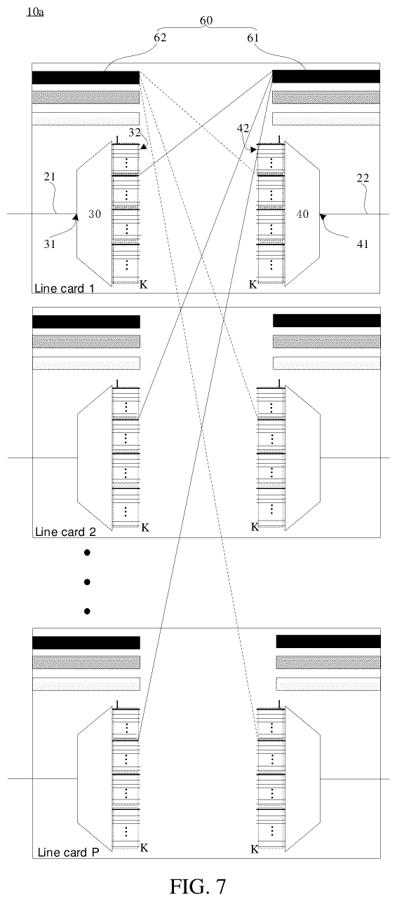

In some embodiments, as shown in FIGS. 7 and 8, the at least one device 10 in the plurality of devices 10 includes the first device 10a, which includes P line cards. Moreover, the plurality of devices 10 further include a third device 10c, and the third device 10c includes Q line cards, where Q is a positive integer less than P.

In the Q line cards, Q branch ports 32 in the first group of branch ports 32 of the first transmission component 30 in each line card are coupled to Q branch ports 42 of Q second transmission components 40, each of the Q branch ports 42 of the Q second transmission components 40 being located in the first group of branch ports 42 of one second transmission component 40; Q branch ports 42 in the first group of branch ports 42 of the second transmission component 40 in each line card are coupled to Q branch ports 32 of Q first transmission components 30, each of the Q branch ports 32 of the Q first transmission components 30 being located in the first group of branch ports 32 of one first transmission component 30. That is, in the third device 10c, Q branch ports 32 in the first group of branch ports 32 of the first transmission component 30 in each line card are in one-to-one correspondence with Q second transmission components 40 in the Q line cards, and each branch port 32 in the first group of branch ports 32 is coupled to one branch port 42 in the first group of branch ports 42 of the respective second transmission component 40; Q branch ports 42 in the first group of branch ports 42 of the second transmission component 40 in each line card are in one-to-one correspondence with Q first transmission components 30 in the Q line cards, and each branch port 42 in the first group of branch ports 42 is coupled to one branch port 32 in the first group of branch ports 32 of the respective first transmission component 30.

In the Q line cards, P branch ports 32 in the second group of branch ports 32 of the first transmission component 30 in each line card are coupled to the first transmission medium 61 of the first transmission medium pair 60 in the line card, and P branch ports 42 in the second group of branch ports 42 of the second transmission component 40 in each line card are coupled to the second transmission medium 62 of the first transmission medium pair 60 in the line card.

The number of line cards included in each of the two coupled devices 10 may be different. In this case, the device including P line cards serves as the first device 10a, and the device including Q line cards serves as the third device 10c. In a case where the number Q of line cards in the third device 10c is less than the number P of line cards in the first device 10a, it can be understood that only Q pairs of data ingress and egress of the third device 10c need to be used to expand Q degrees.

For example, as shown in FIGS. 7 to 9, P=15 and Q=1; as for the coupling between the 15 line cards in the first device 10a, the reference may be made to the description about FIGS. 4A-4G, and in FIG. 7, only the coupling between the line cards and the first transmission medium pair 60 in the first line card is illustrated; in the third device 10c, there is only one line card. In the line card of the third device 10c, the first branch port 32 in the first group of branch ports 32 of the first transmission component 30 is coupled to the first branch port 42 in the first group of branch ports 42 of the second transmission component 40; the 15 branch ports 32 in the second group of branch ports 32 of the first transmission component 30 are coupled to different transmission channels of the first transmission medium 61, which is coupled to the first device 10a; and the 15 branch ports 42 in the second group of branch ports 42 of the second transmission component 40 are coupled to different transmission channels of the second transmission medium 62, which is coupled to the first device 10a.

It should be noted that, when Q is greater than 1, as for the coupling between the transmission medium pair 60 and the first transmission component 30 as well as the second transmission component 40 in the third device 10c, the reference may be made to the above description, which is not repeated here.

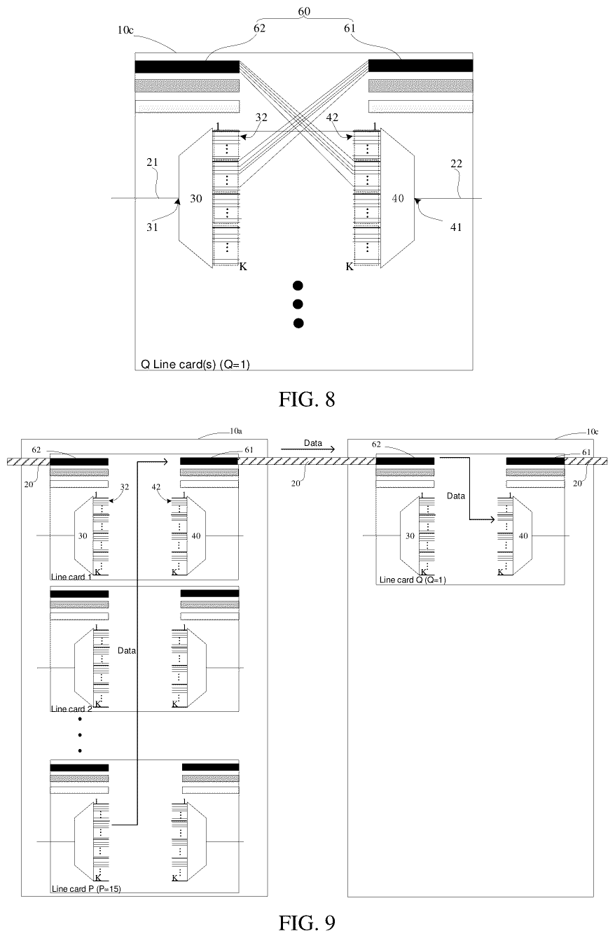

In some embodiments, as shown in FIG. 9, the Q line cards in the third device 10c are in one-to-one correspondence with Q line cards in the first device 10a. For a line card in the first device 10a and a line card in the third device 10c that are correspond to each other, the first transmission medium 61 of the first transmission medium pair 60 in the line card of the first device 10a is coupled to the second transmission medium 62 of the first transmission medium pair 60 in the line card of the third device 10c via a connection line 20, and the second transmission medium 62 of the first transmission medium pair 60 in the line card of the first device 10a is coupled to the first transmission medium 61 of the first transmission medium pair 60 in the line card of the third device 10c via another connection line 20.

The Q line cards in the third device 10c are in one-to-one correspondence with the Q line cards in the first device 10a, which is that the first line card in the third device 10c corresponds to the first line card in the first device 10a, the second line card in the third device 10c corresponds to the second line card in the first device 10a, and the Q-th line card in the third device 10c corresponds to the Q-th line card in the first device 10a.

For example, as shown in FIGS. 7 to 9, P=15 and Q=1; the 15 branch ports 32 in the second group of branch ports 32 of the first transmission component 30 of the line card in the third device 10c are coupled to the first transmission medium 61 of the first transmission medium pair 60 in the line card, and the first transmission medium 61 is coupled to the second transmission medium 62 of the first transmission medium pair 60 in the first line card of the first device 10a, thereby achieving the coupling between the first transmission component 30 in the third device 10c and all second transmission components 40 in the first device 10a; the 15 branch ports 42 in the second group of branch ports 42 of the second transmission component 40 of the line card in the third device 10c are coupled to the second transmission medium 62 of the first transmission medium pair 60 in the line card, and the second transmission medium 62 is coupled to the first transmission medium 61 of the first transmission medium pair 60 in the first line card of the first device 10a, thereby achieving the coupling between the second transmission component 40 in the third device 10c and all first transmission components 30 in the first device 10a.

In a case where data from the fifteenth direction needs to be transmitted to the sixteenth direction, the data may be transmitted from the first transmission component 30 in the fifteenth line card of the first device 10a to the second transmission component 40 in the first line card of the third device 10c through the first transmission medium 61 of the first transmission medium pair 60 in the first line card of the first device 10a and the second transmission medium 62 of the first transmission medium pair 60 in the first line card of the third device 10c, and then output from the output fiber coupled to the second transmission component 40.

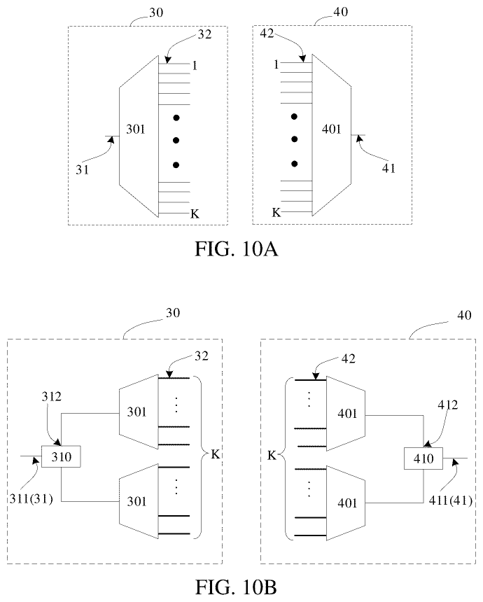

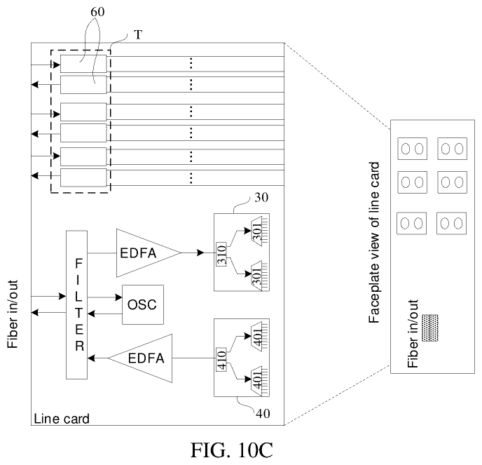

In some embodiments, as shown in FIGS. 10A and 10B, the first transmission component 30 includes at least one first wavelength select switch (WSS), and the second transmission component 40 includes at least one second WSS.

The WSS can support wavelength add/drop at any branch port, which allows different wavelengths to be allocated to different paths. In addition, it has advantages such as wide bandwidth, low dispersion, and low insertion loss.

For example, as shown in FIG. 10A, the first transmission component 30 includes one first WSS 301, which has one common port 31 and K branch ports 32. The second transmission component 40 includes one second WSS 401, which has one common port 41 and K branch ports 42. That is, same WSSs are used to build both the first transmission component 30 and the second transmission component 40. Since the size of WSS can reach 1×32, 1×64, or even 1×128, for some application scenarios with low traffic, only WSS can be used to build the first transmission component 30 and the second transmission component 40.

For another example, as shown in FIG. 10B, the first transmission component 30 includes a splitter 310 with one common port 311 and M branch ports 312, and M first WSSs 301 respectively coupled to the M branch ports 312 of the splitter 310. Each first WSS 301 has K/M branch ports 32. K is greater than M, and both M and K/M are positive integers greater than or equal to 2. The second transmission component 40 includes a combiner 410 with one common port 411 and M branch ports 412, and M second WSSs 401 respectively coupled to the M branch ports 412 of the combiner 410. Each second WSS 401 has K/M branch ports 42.

The splitter 310 is coupled to M 1×K/M first WSSs 301, which is equivalent to a 1×K WSS. Similarly, the combiner 410 is coupled to M 1×K/M second WSSs 401, which is equivalent to a 1×K WSS.

Thus, the common port 311 of the splitter 310 serves as the common port 31 of the first transmission component 30, used for being coupled to the first fiber 21; all the branch ports of the M first WSSs 301 constitute the K branch ports 32 of the first transmission component 30. The common port 411 of the combiner 410 serves as the common port 41 of the second transmission component 40, used for being coupled to the second fiber 22; all the branch ports of the M second WSSs 401 constitute the K branch ports 42 of the second transmission component 40.

According to different types of splitters and combiners, as well as different sizes of WSS, by combining different splitters, combiners and WSS, it is possible to obtain first transmission components and second transmission components with different numbers of branch ports. Thus, it allows the ROADM node to have the capability to expand to higher degrees without being limited by the size of the WSS. Moreover, by using conventional-sized WSSs, it is possible to achieve the expansion of node degrees at a low cost. In addition, although there are M 1×K/M WSSs and M K/M×1 WSSs in each direction, only two WSSs are involved in an optical path connection, with one 1×K/M WSS used for ingress (signal in) and one K/M×1 WSS used for egress (signal out). The polarization dependent loss (PDL) associated with each of two perpendicular polarized light carrying signal information is considered to be lowest when the number of WSSs in the optical path connection is 2. For each WSS, this parameter on average is 0.4 dB.

For example, M is 2, and K/M is 16, 32, or 64. In this case, both the first transmission component 30 and the second transmission component 40 can have 32, 64, or 128 branch ports.

For another example, M is 4, and K/M is 8, 16, 32, or 64. In this case, both the first transmission component 30 and the second transmission component 40 can have 32, 64, 128, or 256 branch ports.

For another example, M is 2, K/M is 32, and T is 3. In this case, the K/M branch ports of each first WSS 301 are divided into 2 groups, and the K/M branch ports of each second WSS 401 are also divided into 2 groups, so that all the branch ports 32 of the first transmission component 30 are divided into 4 groups, and all the branch ports 42 of the second transmission component 40 are divided into 4 groups, with each group including 16 branch ports. Based on this, for any first transmission component 30, 1st to 15th branch ports in the first group of branch ports 32 are used to be coupled to all second transmission components 40 in the same device 10; 1st to 15th branch ports in the second group of branch ports 32 are used to be coupled to first transmission media 61 in first transmission medium pairs 60 of all line cards in the same device 10, and each of the 1st to 15th branch ports in the second group of branch ports 32 is coupled to one transmission channel of a corresponding first transmission medium 61; 1st to 15th branch ports in the third group of branch ports 32 are used to be coupled to first transmission media 61 in second transmission medium pairs 60 of all line cards in the same device 10, and each of the 1st to 15th branch ports in the third group of branch ports 32 is coupled to one transmission channel of a corresponding first transmission medium 61; 1st to 15th branch ports in the fourth group of branch ports 32 are used to be coupled to first transmission media 61 in third transmission medium pairs 60 of all line cards in the same device 10, and each of the 1st to 15th branch ports in the fourth group of branch ports 32 is coupled to one transmission channel of a corresponding first transmission medium 61. Correspondingly, for any second transmission component 40, 1st to 15th branch ports in the first group of branch ports 42 are used to be coupled to all first transmission components 30 in the same device 10; 1st to 15th branch ports in the second group of branch ports 42 are used to be coupled to second transmission media 62 in first transmission medium pairs 60 of all line cards in the same device 10, and each of the 1st to 15th branch ports in the second group of branch ports 42 is coupled to one transmission channel of a corresponding second transmission medium 62; 1st to 15th branch ports in the third group of branch ports 42 are used to be coupled to second transmission media 62 in second transmission medium pairs 60 of all line cards in the same device 10, and each of the 1st to 15th branch ports in the third group of branch ports 42 is coupled to one transmission channel of a corresponding second transmission medium 61; 1st to 15th branch ports in the fourth group of branch ports 42 are used to be coupled to second transmission media 62 in third transmission medium pairs 60 of all line cards in the same device 10, and each of the 1st to 15th branch ports in the fourth group of branch ports 42 is coupled to one transmission channel of a corresponding second transmission medium 61.

FIG. 10C illustrates a structure of a line card. In addition to T transmission medium pairs 60, the first transmission component 30 and the second transmission component 40, the line card may further include a filter, two erbium-doped fiber amplifiers (EDFA), and a circuitry for the optical service channel (OSC). The figure also illustrates the faceplate of the line card, where “fiber in/out” are respectively used for being coupled to input and output fibers, and the transmission medium pairs 60 are coupled to interfaces on the faceplate, thereby achieving the coupling between transmission media of line cards in different chassis through the interfaces.

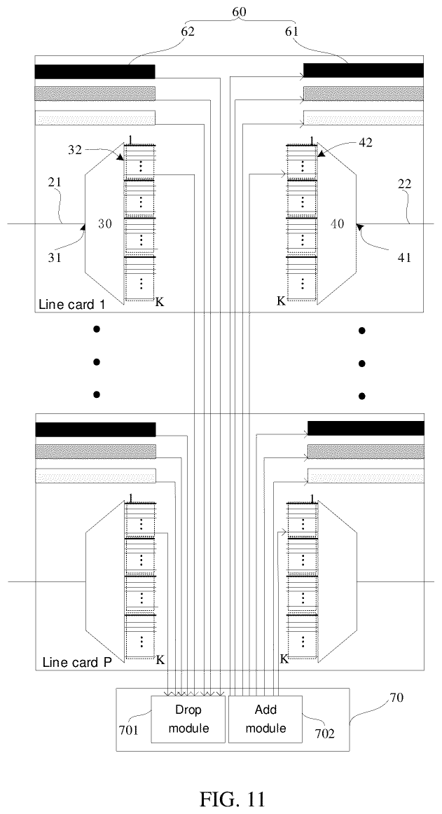

In some embodiments, as shown in FIG. 11, the device 10 further includes an add-drop card 70, and the add-drop card 70 includes a drop module 701 and an add module 702. In the same device 10, the drop module 701 is coupled to one branch port 32 in the first group of branch ports 32 of the first transmission component 30 in each line card and one transmission channel of each of T second transmission media 62 in the T transmission medium pairs 60 in each line card. In the first transmission component 30, the branch port 32 coupled to the drop module 701 is different from the branch ports 32 coupled to the second transmission components 40. In the T second transmission media 62, transmission channels coupled to the drop module 701 are different from those coupled to the second transmission components 40. In the same device 10, the add module 702 is coupled to one branch port 42 in the first group of branch ports 42 of the second transmission component 40 in each line card and one transmission channel of each of T first transmission media 61 in the T transmission medium pairs 60 in each line card. In the second transmission component 40, the branch port 42 coupled to the add module 702 is different from the branch ports 42 coupled to the first transmission components 30. In the T first transmission media 61, transmission channels coupled to the add module 702 are different from those coupled to the first transmission components 30.

The coupling between the drop module 701 and the first transmission component 30 as well as the T second transmission media 62 can be achieved through a plurality of fibers, and the coupling between the add module 702 and the second transmission component 40 as well as the T first transmission media 61 can also be achieved through a plurality of fibers.

The add-drop card 70 may add wavelengths to the optical network and drop wavelengths from the optical network. The drop module 701 is coupled to one branch port 32 in the first group of branch port 32 of the first transmission component 30 and one transmission channel of each of T second transmission media 62 in the T transmission medium pairs 60 in the line card, which is equivalent to that there are (T+1) ports for dropping wavelengths in each degree (direction). The add module 702 is coupled to one branch ports 42 in the first group of branch ports 42 of the second transmission component 40 and one transmission channel of each of T first transmission media 61 in the T transmission medium pairs 60 in the line card, which is equivalent to that there are (T+1) ports for adding wavelengths in each degree (direction). Thus, the add/drop rate may be improved.

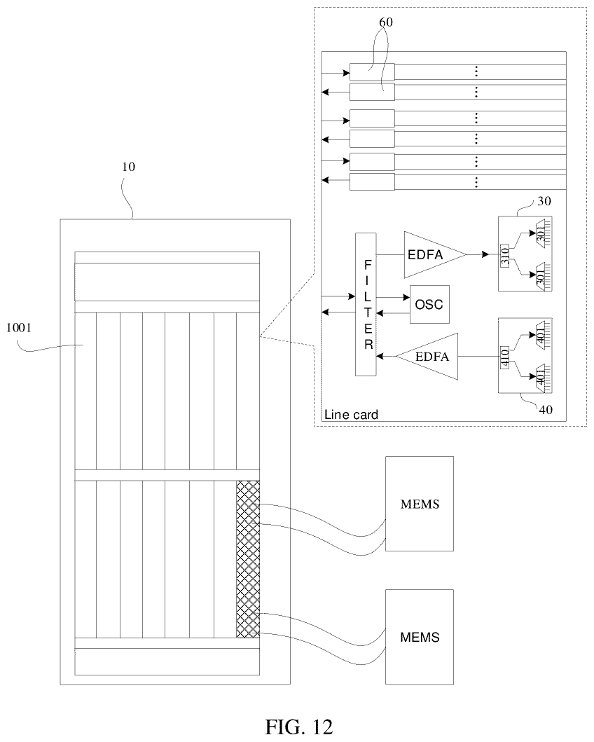

Considering an example in which each chassis has 16 slots, as shown in FIG. 12, the 1st to 15th slots 1001 are used to accommodate 15 line cards, and the 16th slot 1001 is used to accommodate the add-drop card 70. It should be noted that, the number of line cards is not limited to 15, it may be any number; the embodiments of the present disclosure are not limited to one add-drop card 70, and the number of add-drop cards 70 in the chassis may be two or more. For example, in the case where there is one add-drop card 70 in the chassis, for the convenience of expansion, even if the number of line cards in a certain device 10 is less than 15, the add-drop card 70 may still be placed in the 16th slot 1001.

In some embodiments, the add module 702 includes (T+1) multiplexers corresponding to each line card, and the drop module 701 includes (T+1) de-multiplexers corresponding to each line card.

The number of multiplexers in the add module 702 and the number of de-multiplexers in the drop module 701 depend on the number of line cards in the device 10. If the number of line cards in the device 10 is S, then the number of multiplexers in the add module 702 and the number of de-multiplexers in the drop module 701 are both S×(T+1). For example, if the number of line cards in the device 10 is 15, and T is 3, then the number of multiplexers in the add module 702 and the number of de-multiplexers in the drop module 701 are both 60.

The multiplexers included in the add module 702 may multiplex data signals that are input from a plurality of ports and need to be added (i.e., multiplex a plurality of wavelengths), and add the data signals to the device for transmission in the optical network. The de-multiplexers included in the drop module 701 may de-multiplex data signals that need to be dropped (i.e., de-multiplex the data signals into a plurality of wavelengths), and the data signals may be dropped from the device through a plurality of ports.

In some embodiments, the de-multiplexer is a WSS; the multiplexer is a WSS.

For example, the de-multiplexer is a 1×4 WSS or 1×8 WSS. The multiplexer is also a 1×4 WSS or 1×8 WSS.

In the case where the number of line cards in the device 10 is 15, and T is 3, each line card is coupled to four de-multiplexers via four fibers and coupled to four multiplexers via four fibers. For any line card, the 16th branch port of the first group of branch ports 32 in the first transmission component 30 is coupled to the drop module 701 via one fiber, and the 16th transmission channel of each of the T second transmission media 62 is coupled to the drop module 701 via one fiber; thus, the drop module 701 in the device 10 is coupled to fibers with the total number of 15+15×3=60. The 16th branch port of the first group of branch ports 42 in the second transmission component 40 is coupled to the add module 702 via one fiber, and the 16th transmission channel of each of the T first transmission media 61 is coupled to the add module 702 via one optical fiber; thus, the add module 702 in the device 10 is coupled to fibers with the total number of 15+15×3=60. In the case where both the de-multiplexer and multiplexer adopt 1×4 WSS, the drop module 701 can de-multiplex 240 wavelengths, and the add module 702 can multiplex 240 wavelengths; in the case where both the de-multiplexer and multiplexer adopt 1×8 WSS, the drop module 701 can de-multiplex 480 wavelengths, and the add module 702 can multiplex 480 wavelengths.

In the ROADM node, due to the ability of WSS to select the port from which the wavelength is output, WSSs are used as the de-multiplexer and multiplexer, which allows the ROADM node to flexibly add/drop wavelengths.

In some embodiments, the distributed device cluster further includes a plurality of micro-electro-mechanical systems (MEMSs). The add module 702 of each device 10 is connected to one MEMS, and the drop module 701 of each device 10 is connected to another MEMS.

MEMS is a type of optical switch composed of mirrors. It utilizes mirrors to switch input to its desired output. The size of MEMS is represented by the product of two positive integers. For example, a MEMS with a size of 256×256 means that it can switch a wavelength input from any of 256 input ports to any of 256 output ports.

It can be understood that, in the case where both the de-multiplexer and multiplexer adopt 1×4 WSS, the MEMS with the size of 256×256 can be selected, and in the case where both the de-multiplexer and multiplexer adopt 1×8 WSS, the MEMS with the size of 512×512 can be selected.

In the case where both the de-multiplexer and multiplexer adopt 1×4 WSS, during adding wavelengths, a transceiver inputs wavelengths from 240 input ports of the MEMS connected thereto, these wavelengths are multiplexed by the multiplexers of the add module 702 and then transmit to second transmission components 40 and first transmission media 61 of the device 10 through 60 ports of the add module 702. During dropping wavelengths, wavelengths from first transmission components 30 and second transmission media 62 of the device 10 enter de-multiplexers through 60 ports of the drop module 701 and then transmitted to the transceiver through 240 output ports of the MEMS. Therefore, for each MEMS, the number of input and output ports needs to be greater than 240. Thus, either a 256×256 MEMS or a 512×512 MEMS can be used.

In the ROADM node, the sizes of the de-multiplexer and multiplexer may determine an add/drop rate. In an example where the ROADM node includes four devices 10, each device 10 has 15 line cards, and T=3, each drop module 701 is coupled to 60 fibers for wavelength dropping; if each fiber feeds into one 1×4 de-multiplexer, the wavelengths from these 60 fibers are de-multiplexed into 240 wavelengths, and the ROADM node can drop a total of 4×240=960 wavelengths. If each input fiber can transmit 80 wavelengths, the drop rate of the ROADM node is 960/(60×80)=20%. It can be understood that the calculation for the add rate of the ROADM node is the same as that of the drop rate, it is also 20%.

If each fiber feeds into one 1×8 de-multiplexer or one 1×8 multiplexer, the drop rate and add rate of the ROADM node will double, reaching 40%.

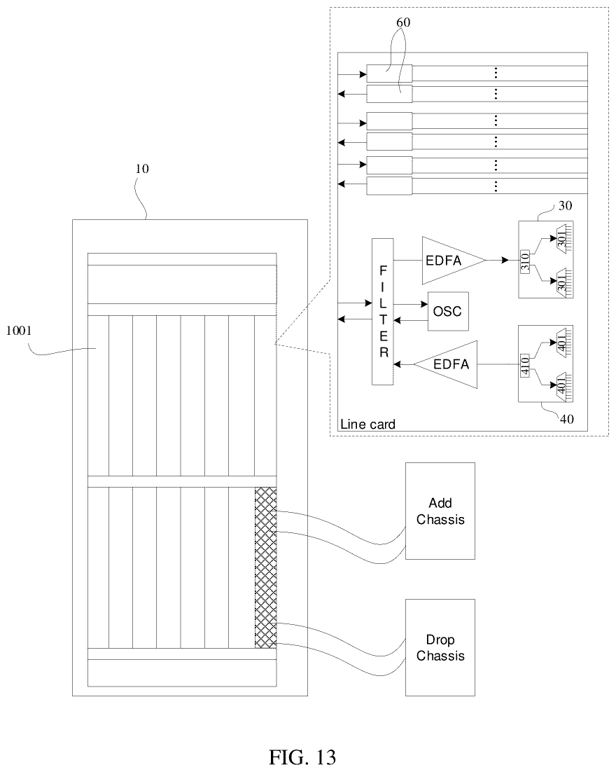

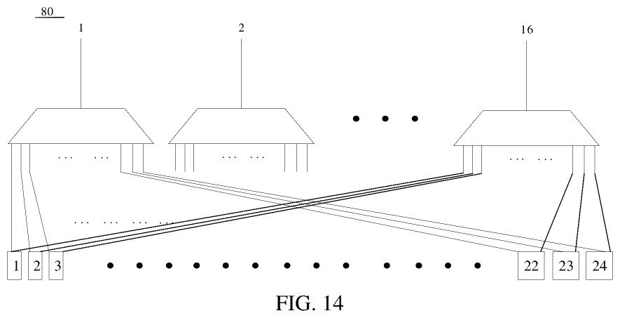

In some embodiments, as shown in FIGS. 13 and 14, the ROADM node further includes a plurality of add chassis and a plurality of drop chassis, each add chassis includes a plurality of CDC cards 80 and each drop chassis includes a plurality of CDC cards 80. The add module 702 in each device 10 is connected to all CDC cards 80 in an add chassis, and the drop module 701 in each device 10 is connected to all CDC cards 80 in a drop chassis. The CDC card 80 is an add-drop component that is colorless, directionless, and contentionless.

The CDC card 80 is a component used for adding/dropping wavelengths in the ROADM node.

For example, as shown in FIG. 14, a CDC card with a size of 16×24 is considered as a collection of 16 WSSs with a size of 1×24. In this way, for any CDC card, wavelengths from the device can be input from any of the 16 first ports and output from any of the 24 second ports, or wavelengths input from any of the 24 second ports can be input into the device through any of the 16 first ports. For example, the size of the CDC card is 16×30. For another example, the size of the CDC card is 16×32.

For example, the drop module 701 in the device 10 is coupled to 60 fibers, and the de-multiplexer adopts the 1×4 WSS; the drop chassis includes 16 slots, each slot is inserted a 16×24 CDC card. Therefore, for each CDC card, only 15 first ports are used, and 16×15=240 first ports are provided by the drop chassis for meeting the requirement of transmitting data to the transceiver by the drop module 701.

For example, the add module 702 in the device 10 is coupled to 60 fibers, and the multiplexer adopts the 1×4 WSS; the add chassis includes 16 slots, each slot is inserted a 16×24 CDC card. Therefore, for each CDC card, only 15 first ports are used, and 16×15=240 first ports are provided by the add chassis for meeting the requirement of transmitting data to the add module 702 from the transceiver.

It can be understood that the number of first ports of the CDC and the number of second ports of the CDC card are not limited, and they can be determined based on the size of the chassis and the capacity of the WSS in the line card.

In some embodiments, as shown in FIG. 15, the device 10 in the ROADM node further includes a controller 901. The ROADM node further includes a master controller 902 coupled to all controllers of the devices 10.

In each device 10 of the ROADM node, the data transmission (i.e., wavelength transmission) between the first transmission component 30 and the second transmission component 40, between the first transmission component 30 and the first transmission medium 61, and between the second transmission medium 62 and the second transmission component 40 are all controlled by the controller 901 in the device 10.

For example, the controller 901 determines a first transmission component 30 and a second transmission component 40 in the device 10 involved in the wavelength transmission connection. That is, the controller 901 determines which branch port 32 of the first transmission component 30 establishes a connection with which second transmission component 40. The controller 901 also determines a first transmission component 30 and a first transmission medium 61 in the device 10 involved in the wavelength transmission connection. That is, the controller 901 determines which branch port 32 of the first transmission component 30 establishes a connection with which first transmission medium 61. The controller 901 also determines a second transmission component 40 and a second transmission medium 62 in the device 10 involved in the wavelength transmission connection. That is, the controller 901 determines which branch port 42 of the second transmission component 40 establishes a connection with which second transmission medium 62.

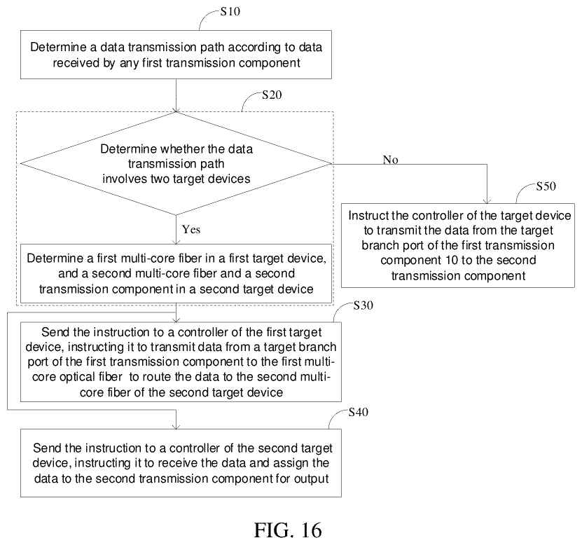

As shown in FIG. 16, the master controller 902 is configured to: determine a data transmission path according to data received by any first transmission component (S10); in a case of determining the data transmission path involving two target devices, determine a first transmission medium in a first target device, and a second transmission medium and a second transmission component in a second target device through which data transmission passes, and then generate an instruction (S20); send the instruction to a controller of the first target device (S30), instructing the controller of the first target device to transmit data from a target branch port of the first transmission component to the first transmission medium to route the data to the second transmission medium of the second target device; and send the instruction to a controller of the second target device (S40), instructing the controller of the second target device to receive the data from the first target device and assign the data to the second transmission component for output.

After data is received by the first transmission component 30 from the input fiber connected thereto, the master controller 902 determines the data transmission path according to a direction in which the data needs to be output, that is, determines which branch port 32 of the first transmission component 30 should output the data and which second transmission component 40 should receive the data.

In a case where the ingress component (first transmission component 30) and the egress component (second transmission component 40) for data transmission are not in the same device 10, the master controller 902 determines that the data transmission path involves two target devices 10, then determines the first target device corresponding to the first transmission component 30 and the second target device corresponding to the second transmission component 40, and determines a first transmission medium 61 in the first target device, and a second transmission medium 62 in the second target device through which data transmission passes.

Then, the master controller 902 sends the instruction to the controller 901 of the first target device, instructing it to transmit the data from the target branch port 32 of the first transmission component 30 to the first transmission medium 61 to route the data to the second transmission medium 62 of the second target device.

The master controller 902 also sends the instruction to the controller 901 of the second target device, instructing it to receive the data from the first target device and assign it to the second transmission component 40 for output.

The master controller 902 is further configured to, in a case of determining the data transmission path involving one target device 10, instruct the controller 901 of the target device to transmit the data from the target branch port 32 of the first transmission component 10 to the second transmission component 20 for output (S50).

In the case where the master controller 902 determines that the data transmission path involves one target device 10, the main controller 902 sends the instruction to the controller 901 of target device 10, instructing it to output the data from the target branch port 32 of the first transmission component 30 to the second transmission component 40 through the optical backplane.

After the connection is established by the controller, the data can flow through the connection. In addition, the master controller 902 can also control the controller 901 to release the connection.

The foregoing descriptions are merely specific implementations of the present disclosure, but the protection scope of the present disclosure is not limited thereto. Changes or replacements that any person skilled in the art could conceive of within the technical scope of the present disclosure shall be included in the protection scope of the present disclosure. Therefore, the protection scope of the present disclosure shall be subject to the protection scope of the claims.

What is claimed is:

1. A distributed device cluster, comprising:
a plurality of devices, wherein each device includes at least one pair of transmission components each including a first transmission component and a second transmission component that are coupled to each other; and
a plurality of connection lines;
wherein for any two of the plurality of devices, a first transmission component in one device is coupled to a second transmission component in another device via at least one connection line.

2. The distributed device cluster according to claim 1, wherein the device further includes an inter-connection component, the first transmission component and the second transmission component in the device are coupled via the inter-connection component, and the inter-connection component is used for transmitting at least a portion of data from the first transmission component to the second transmission component.

3. The distributed device cluster according to claim 2, wherein the inter-connection component is a switch;
for any two of the plurality of devices, the first transmission component in one device is coupled to the at least one connection line, and the switch and the second transmission component in another device in sequence.

4. The distributed device cluster according to claim 2, wherein the first transmission component has one common port for coupling with a first fiber, and K branch ports; the second transmission component has one common port for coupling with a second fiber, and K branch ports; K is a positive integer;
each pair of transmission components is located in at least one line card, and the line card further includes T transmission medium pairs each including a first transmission medium with transmission channels and a second transmission medium with transmission channels; the T transmission medium pairs are used for coupling with different devices of the plurality of devices;
the K branch ports of the first transmission component are divided into T+1 groups of branch ports, and the K branch ports of the second transmission component are divided into T+1 groups of branch ports; in the line card, a first group of branch ports in the first transmission component and a first group of branch ports in the second transmission component are coupled, an i-th group of branch ports in the first transmission component and a first transmission medium of an (i−1)-th transmission medium pair are coupled, and an i-th group of branch ports in the second transmission component and a second transmission medium of the (i−1)-th transmission medium pair are coupled; i is a positive integer greater than or equal to 2 and less than or equal to (T+1), T is a positive integer, and K is greater than (T+1); and
for any two of the plurality of devices, a first transmission medium in one device is coupled to a second transmission medium in another device via a connection line, and a second transmission medium in one device is coupled to a first transmission medium in the other device via another connection line.

5. The distributed device cluster according to claim 4, wherein T is greater than or equal to 2.

6. The distributed device cluster according to claim 4, wherein the inter-connection component is an optical backplane;
the first transmission component and the second transmission component, the first transmission component and the first transmission medium, and the second transmission component and the second transmission medium are coupled via the optical backplane.

7. The distributed device cluster according to claim 4, wherein the first transmission component in each line card is fully connected to second transmission components in all line cards in the distributed device cluster; and/or
the second transmission component in each line card is fully connected to first transmission components in all line cards in the distributed device cluster.

8. The distributed device cluster according to claim 7, wherein at least one of the plurality of devices includes P line cards;
in the P line cards, P branch ports in the first group of branch ports of the first transmission component in each line card are coupled to P branch ports of P second transmission components, each of the P branch ports of the P second transmission components being located in the first group of branch ports of one second transmission component; P is an integer greater than or equal to 2; and
in the P line cards, P branch ports in the i-th group of branch ports of the first transmission component in each line card are coupled to P first transmission media, each of the P first transmission media being located in an (i−1)-th transmission medium pair in one line card.

9. The distributed device cluster according to claim 8, wherein in the P line cards, P branch ports in the first group of branch ports of the second transmission component in each line card are coupled to P branch ports of P first transmission components, each of the P branch ports of the P first transmission components being located in the first group of branch ports of one first transmission component; and
in the P line cards, P branch ports in the i-th group of branch ports of the second transmission component in each line card are coupled to P second transmission media, each of the P second transmission media being located in an (i−1)-th transmission medium pair in one line card.

10. The distributed device cluster according to claim 9, wherein the at least one device includes at least two devices; any two of the at least two devices are referred to as a first device and a second device, and the P line cards in the first device are in one-to-one correspondence with the P line cards in the second device;
for a line card in the first device and a line card in the second device that are correspond, the first transmission medium of one transmission medium pair in the line card of the first device is coupled to the second transmission medium of one transmission medium pair in the line card of the second device via a connection line, and the second transmission medium of the transmission medium pair in the line card of the first device is coupled to the first transmission medium of the transmission medium pair in the line card of the second device via another connection line.

11. The distributed device cluster according to claim 9, wherein the at least one of the plurality of devices includes a first device, and the plurality of devices further include a third device; and the third device includes Q line cards, Q is a positive integer less than P;
in the Q line cards, Q branch ports in the first group of branch ports of the first transmission component in each line card are coupled to Q branch ports of Q second transmission components, each of the Q branch ports of the Q second transmission components being located in the first group of branch ports of one second transmission component; and Q branch ports in the first group of branch ports of the second transmission component in each line card are coupled to Q branch ports of Q first transmission components, each of the Q branch ports of the Q first transmission components being located in the first group of branch ports of one first transmission component;
in the Q line cards, P branch ports in a second group of branch ports of the first transmission component in each line card are coupled to the first transmission medium of a first transmission medium pair in the line card, and P branch ports in a second group of branch ports of the second transmission component in each line card are coupled to the second transmission medium of the first transmission medium pair in the line card.

12. The distributed device cluster according to claim 11, wherein the Q line cards in the third device are in one-to-one correspondence with Q line cards in the first device;
for a line card in the first device and a line card in the third device that are correspond, the first transmission medium of the first transmission medium pair in the line card of the first device is coupled to the second transmission medium of the first transmission medium pair in the line card of the third device via a connection line, and the second transmission medium of the first transmission medium pair in the line card of the first device is coupled to the first transmission medium of the first transmission medium pair in the line card of the third device via another connection line.

13. The distributed device cluster according to claim 4, wherein the first transmission component includes at least one first wavelength select switch (WSS), and the second transmission component includes at least one second WSS.

14. The distributed device cluster according to claim 13, wherein the first transmission component includes a splitter with one common port and M branch ports, and M first WSSs respectively coupled to the M branch ports of the splitter, each first WSS having K/M branch ports; K is greater than M, and both M and K/M are positive integers greater than or equal to 2; and/or
the second transmission component includes a combiner with one common port and M branch ports, and M second WSSs respectively coupled to the M branch ports of the combiner, each second WSS having K/M branch ports.

15. The distributed device cluster according to claim 4, wherein the device further includes an add-drop card, and the add-drop card includes an add module and a drop module;
the drop module is coupled to one branch port in the first group of branch ports of the first transmission component and one transmission channel of each of T second transmission media in the T transmission medium pairs in each line card; in the first transmission component, the branch port coupled to the drop module is different from branch ports coupled to second transmission components; in the T second transmission media, transmission channels coupled to the drop module are different from those coupled to second transmission components; and
the add module is coupled to one branch port in the first group of branch ports of the second transmission component and one transmission channel of each of T first transmission media in the T transmission medium pairs in each line card; in the second transmission component, the branch port coupled to the add module is different from branch ports coupled to first transmission components; in the T first transmission media, transmission channels coupled to the add module are different from those coupled to first transmission components.

16. The distributed device cluster according to claim 15, wherein the add module includes (T+1) multiplexers corresponding to each line card, and the drop module includes (T+1) de-multiplexers corresponding to each line card.

17. The distributed device cluster according to claim 16, wherein a de-multiplexer is a wavelength select switch (WSS); and/or
a multiplexer is a WSS.

18. The distributed device cluster according to claim 16, further comprising a plurality of micro-electro-mechanical system (MEMS);
the add module of each device is connected to an MEMS, and the drop module of each device is connected to another MEMS.

19. The distributed device cluster according to claim 16, further comprising a plurality of add chassis and a plurality of drop chassis, wherein each add chassis includes a plurality of CDC cards and each drop chassis includes a plurality of CDC cards;
the add module in each device is connected to all CDC cards in an add chassis, and the drop module in each device is connected to all CDC cards in a drop chassis, a CDC card being an add-drop component that is colorless, directionless, and contentionless.

20. The distributed device cluster according to claim 4, further comprising a master controller, wherein
the device further includes a controller coupled to the master controller;
the master controller is configured to: determine a data transmission path according to data received by any first transmission component; in a case of determining the data transmission path involving two target devices, determine a first transmission medium in a first target device, and a second transmission medium and a second transmission component in a second target device through which data transmission passes, and then generate an instruction;
send the instruction to a controller of the first target device, instructing the controller of the first target device to transmit data from a target branch port of the first transmission component to the first transmission medium to route the data to the second transmission medium of the second target device; and send the instruction to a controller of the second target device, instructing the controller of the second target device to receive the data from the first target device and assign the data to the second transmission component for output; and
the master controller is further configured to, in a case of determining the data transmission path involving one target device, instruct a controller of the target device to transmit the data from the target branch port of the first transmission component to the second transmission component for output.
